(19) United States
(12) Patent Application Publication
(10) Pub. No.: US 2020/0203952 A1
(43) Pub. Date: Jun. 25, 2020

(54) APPARATUS AND METHOD FOR ACTIVE GENERATION AND APPLICATION OF REACTIVE POWER IN INDUCTIVE TRANSMISSION SYSTEMS

(71) Applicant: OTTO-VON-GUERICKE-UNIVERSITAT MAGDEBURG, Magdeburg (DE)

(72) Inventor: Carsten Kempiak, Sulzetal (DE)

(73) Assignee: OTTO-VON-GUERICKE-UNIVERSITAT MAGDEBURG, Magdeburg (DE)

(21) Appl. No.: 16/622,271

(22) PCT Filed: Jun. 18, 2018
(86) PCT No.: PCT/DE2018/100570

§ 371 Date: Dec. 12, 2019

(30) Foreign Application Priority Data
Jun. 19, 2017 (DE) 10 2017 113 425.5

(51) Int. Cl. H02J 3/18; H02M 3/335; H02J 50/12

(52) U.S. Cl. CPC H02J 3/18; H02J 50/12; H02M 3/33507

(57) ABSTRACT

The invention relates to apparatus (3) and a method for the active generation and application of reactive power in an inductive transmission system (12), the apparatus comprising at least one device (1) for the active generation of reactive power. The reactive power can be actively generated by a power electronics actuator comprising at least one power electronics circuit (1.1) and an intermediate electric energy store (1.2). The apparatus also comprises a device (2) for coupling in reactive power and the reactive power generated by the device (1) can be coupled into the inductive transmission system (12) by means of a capacitor.

The invention relates to an apparatus and a method for the active generation and application or injection of reactive power into inductive transmission systems.

In the case of energy transmission without contact over weakly coupled coils, large stray fields arise, from which a high reactive power requirement of the transmission system results. Therefore, it is necessary to compensate the inductive reactive power for an efficient energy transmission. Used for this purpose are primary-side and secondary-side capacitors, whose dimensions essentially determine the performance of the system.

Here, the high efficiency of inductive transmission systems in the range of 90%—and even in part above—is known. It is also known that this high efficiency always refers here to the rated operating point, i.e., under full load, optimal balance and optimal positioning.

Under partial load or with variations in parameters or position, the efficiency and the transmissible effective power decrease as a consequence of the high sensitivity of the transmission system to rapid parameter variations. In particular, the increasing reactive power requirement of the coil system with erroneous positioning, in addition to a poorer efficiency, also leads to heightened magnetic field emissions and to poorer switching conditions of the power semiconductor, for which reason an over-dimensioning is necessary.

The indicated disadvantages can be avoided by a tracking of the ideal balance. Thus, in the case of all investigated disruptive influences, an increased reactive power requirement of the transmission system does not arise, so that the transmissible effective power and the efficiency can be increased when variations in parameters and positioning occur, while there is a simultaneous decrease in the system costs. Ideal, continuously adjustable capacities are employed for tracking the balance during operation of the devices. Realizing this variable compensation, however, has proven to be difficult.

In the regulation of inductive transmission systems, primary-side and secondary-side regulating methods can be distinguished. Since the output value to be regulated is applied to the secondary side, an additional communication channel, which increases the complexity of the system and limits the regulating dynamics, is required for the primary-side regulating method. Also, primary-side regulation is not suitable for systems with a plurality of outlets or consumers, so that the field of application is limited.

In the case of secondary-side regulation, a distinction is made essentially between regulation with an additional DC/DC converter and short circuit control. If a DC/DC converter is employed for the regulation, in addition to the active actuator, a DC intermediate circuit is necessary, which increases the required installation space, the weight, and the system costs. By means of the short circuit control, in systems with current output via short-circuiting the load, the output power may be limited.

In systems with voltage output—analogous to short-circuiting of the load circuit in systems with current output—the load circuit is open, i.e., it is operated with an idle control in order to limit the output power. In this case, in addition to eliminating the DC intermediate circuit, a higher efficiency is attained than with the use of a DC/DC converter. With both methods, the output power can only be limited. An increase in the power consumed, e.g., in the case of erroneous positioning, is not possible.

It is likewise known that manipulation of the compensation capacitors during operation is also suitable for the secondary-side regulation of the output values. Here, by decreasing the apparent power taken up, with the same effective power uptake of the secondary side, a high efficiency can be achieved in the partial-load region. For this purpose, of course, a continuous, dynamic, and loss-poor corrective intervention is necessary during operation in order to manipulate the compensation capacitors.

Also known is an apparatus in which, for a variable compensation capacitor, a switched fixed impedance with PWM control is present. In this case, the switching frequency should at least correspond to the resonance frequency. An actuation with a clearly higher frequency is not practicable due to the high resonance frequency, so that the variable capacity is produced by way of switching on a fixed impedance for n switching periods and the switching processes are synchronized with the zero passages of the voltage via the switch. However, a discontinuous loading of the feeding inverter arises in this way, which leads to a tendency for the output current of the inverter to oscillate. This results in increased losses on the primary side, increased magnetic field emissions, and poorer switching conditions of the power semiconductor.

This can be avoided if the current is adjusted via the additional impedance with phase-shift actuation, such as is disclosed in WO 2004/105208 A1. Of course, in this approach, a synchronization of the switching processes with the zero passages of the voltage by way of switches is not possible, since it leads to high switching losses and high-frequency oscillations due to the difficult switching processes. Further, a high component loading due to the switching in the resonance circuit needs to be considered, since it makes necessary the use of large, expensive, and slowly switching IGBT modules.

In DE 10 2015 005 927 A1, an apparatus and a method are described for the adaptive fitting of the compensation to a discrete capacitor bank composed of n switchable capacitors. For adapting the compensation, it is proposed that the latter is switched on or off statically. Transient over-voltages due to rapid switching processes at the switches do not occur thereby. Of course, a large, heavy, and expensive capacitor bank is required. Further, the discontinuous step width of the capacitor array gives rise to an error in the balance, which leads to a lesser efficiency as well as a lower transmissible effective power. This method is also not suitable for continuous regulation of the output values, for which reason another actuator is necessary.

In WO 99/26329, a variable inductivity is described for tracking the balance and for regulating the output voltage, the permeability of which is modified via an injected direct current, in order to drive the coils in saturation in a targeted manner and to vary the effective inductivity. In order to ensure a stable operation with this highly nonlinear adjusting principle, however, a complex regulating algorithm with adaptive step width is necessary.

A search algorithm based on fuzzy logic can be utilized for this. This algorithm is dependent on the application and must be adapted for each system. Further, a dynamic regulation is not possible with this adjusting principle, which is intolerable for several applications.

Against this background, the object of the present invention is to overcome the indicated disadvantages.

This object is achieved with an apparatus according to claim 1 and a method according to claim 9. Further advantageous embodiments are derived from the dependent claims.

Proposed is an apparatus (3) for the active generation and injection of a reactive power into an inductive transmission system (12), this apparatus comprising at least:
a device (1) for the active generation of a reactive power, wherein the reactive power can be actively generated by means of a power electronics actuator, this device comprising at least one power electronics circuit (1.1) and an intermediate electric energy store (1.2);
a device (2) for coupling in reactive power, wherein the reactive power generated by the device (1) can be coupled into the inductive transmission system (12) via a transformer.

The invention is based on actively generating reactive power by means of power electronics in a system parallel to the inductive transmission system and on feeding it into the compensated coil system (4) for adapting the compensation.

In this way, the active injection of reactive power makes possible a continuous, dynamic, and efficient variation of the compensation during the energy transmission process, thus during operation, whereby this new approach to a solution offers the potential for a plurality of advantages. In particular, these include:
Equilibration of parameter variations during operation
Increase in positioning tolerance
Realization of a robust and highly efficient regulation
Reduction in costs due to avoiding over-dimensioning
More degrees of freedom during operation of inductive transmission systems

“Active generation” is understood to mean that the reactive power is generated by means of power electronics.

According to the invention, this involves a power electronics circuit, which comprises at least two controllable power semiconductor components. In addition to a control for the power electronics, a regulation has also proven to be advantageous.

One embodiment of the invention for the apparatus (3) provides that the feeding of the device (1) for the active generation of reactive power is produced
from the inductive transmission system (12) or
from an additional energy source.

In addition, it is provided that capacitive and/or inductive reactive power can be generated by means of the device (1).

In an enhancement of the invention, the coupling-in of the reactive power (2) is produced in series and/or parallel to one or more compensation capacitors.

Advantageously, the reactive power coupling-in (2) can be produced in series and/or parallel to a coil system (7).

One embodiment of the invention provides that the reactive power coupling-in (2) is produced in series and/or parallel to a compensated coil system (4).

An enhancement of the invention provides that the reactive power coupling-in (2) is produced on the primary side (P) and/or on the secondary side (S) of the inductive transmission system (12).

Advantageously, at least one reactive power coupling-in (2) is produced; however, in addition, a plurality of reactive power couplings can be produced.

We propose a method for the operation of the apparatus (3), which is characterized in that the compensation of the inductive transmission system (12) is varied by active generation and injection of reactive power into the compensated coil system (4).

Advantageously, the method is characterized in that the compensation is varied continuously or continuously tracked during the operation of the inductive transmission system (12).

The method according to the invention can also be characterized in that the compensation is detuned during operation by injection of a reactive power into the compensated coil system (4), in order to regulate at least one electrical value of the inductive transmission system (12), wherein preferably the flooding of the primary coil (L₁) and/or the voltage at the primary coil or the secondary coil (L₂) is regulated.

“Detuning” of the inductive transmission system (12) is understood as follows, in that the inductive transmission system is brought out of resonance by active introduction of a reactive power into the compensated coil system.

The method can be characterized in that the compensation is detuned during operation, in order to regulate at least one electrical output value of the inductive transmission system.

One embodiment of the method according to the invention for the operation of the apparatus (3) can be characterized in that the ratio between two electrical values of the inductive transmission system is varied, preferably is continuously varied during operation, by active generation and injection of reactive power.

In addition, the method can also be characterized in that the phase angle between the output voltage and the output current of the feeding inverter is varied and/or is limited, preferably is continually varied and/or limited during operation, by active generation and injection of reactive power.

The active injection of reactive power represents a suitable method for the continuous, dynamic, and efficient manipulation of the compensation capacities during operation. A robust and simultaneously highly efficient operation of inductive transmission systems can be realized according to the invention. By tracking the balance during operation, position tolerances, component tolerances, temperature drift, and aging phenomena of the actual structural components can be equilibrated in an automatic manner. At the same time, the targeted detuning of the compensation can be utilized for the regulation of the output values.

In this way, on the one hand, another actuator, which would otherwise be necessary for the regulation, is eliminated, and an over-dimensioning is avoided, which minimizes costs and structural size, and, on the other hand, achieves a higher efficiency in the partial load region. These aspects are particularly interesting for applications with variable positioning, such as, for example, the inductive charging of electric vehicles, and for applications that are operated for a large part in the partial load region, which are encountered many times.

In turn, an example of this is charging systems: Modern Li batteries must be charged with a charging voltage that is lower than the rated voltage in the case of a low state of charge and with a small charging current in the case of a high state of charge. Therefore, they are found in the partial load region for a large part of the charging process.

The solution according to the invention leads to a clearly higher efficiency in the partial load region, and, due to the active injection of reactive power, leads to an increase in energy efficiency for the overall charging process, in particular in charging systems of higher power. Further, with a continuous manipulation of the compensation during operation, new degrees of freedom result, since the compensation has an influence on numerous system parameters.

Thus, the active injection of reactive power, for example, in a secondary-side regulation, can be utilized for adapting the current/voltage ratio, in order to increase the charging current in the case of inductive charging with a low charging voltage and thus to reduce the charging time. The solution according to the invention offers a potential for realizing a plurality of optimized, application-specific operating strategies for inductive transmission systems, whereby a broad utilization potential directly results for inductive energy transmission applications. Therefore, application of the active injection of reactive power for tracking the balance during operation, regulation of the output values, and targeted manipulation of the compensation have the potential to essentially broaden existing designs in several fields.

The apparatus and the method can be used, for example, in the following fields:
for inductive energy transmissions in rail transport; thus, the electrical/mechanical wear of overhead lines and current collectors can be avoided, which decreases maintenance expenditure and thus operating costs and increases operating safety, by avoiding electric arcs as a consequence of contact problems that increasingly occur with higher speeds; also, one must take into consideration an expansion of high-speed rail networks, for which a contact-free energy supply is particularly suitable; based on the high power to be transmitted as well as long operating times, the efficiency increase aimed at with the adjusting principle of this invention as well as the ensuring of a robust operation over the entire service life of the systems are of particular interest for this field of application;
for inductive energy transmission, i.e., for the contact-free charging of electric vehicles by the use of reliable, efficient, and interoperable inductive charging systems; by means of this active injection of reactive power, a robust and a highly efficient operation of inductive charging systems can be achieved in actual application, when considered over the entire charging process; by means of the inductive charging of electric vehicles, the charging process can be completely automated; this offers the possibility of integrating electric vehicles in an intelligent power grid; in this way, electric vehicles can be used as a mobile energy store for buffering the fluctuating supply from wind and solar power, in order to stabilize power grids and to increase the proportion of renewable energy in the grid; by an intelligent management of charging, it is further possible for the end user to participate in the fluctuating prices of the power market in that the electric vehicle automatically feeds back a part of the stored energy into the power grid, e.g., when there is no wind, the user being compensated for this, and with a larger feeding-in of renewable energy, the battery is charged at a lower price;
in the construction of complex industrial plants, where, for example, construction-caused distances of several millimeters to several centimeters must be bridged without contact; also in the field of production and logistics, the supplying of movable or rotating consumers, such as, e.g., driverless transport systems, forklifts, robotic arms or interchangeable machine tools, as well as the energy supply for sensors and actuators in rough and safety-critical environments represent typical applications for the apparatus according to the invention;
in the medical technology field, such as, for example, in contact-free supplying of implants,
in clean room applications and in the food products industry for health safety reasons,
for contact-free charging of small devices, such as toothbrushes or smart phones, and the like.

In the following, the invention will be explained on the basis of figures, whereby the invention is not limited thereto:

Herein:

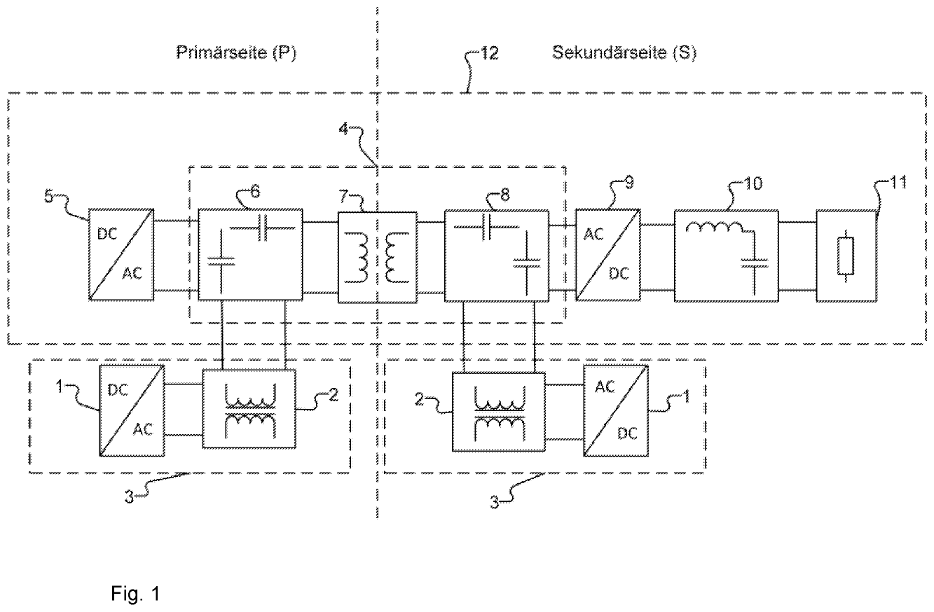

FIG. 1: shows schematically an inductive transmission system with active injection of reactive power on both sides and a DC load;

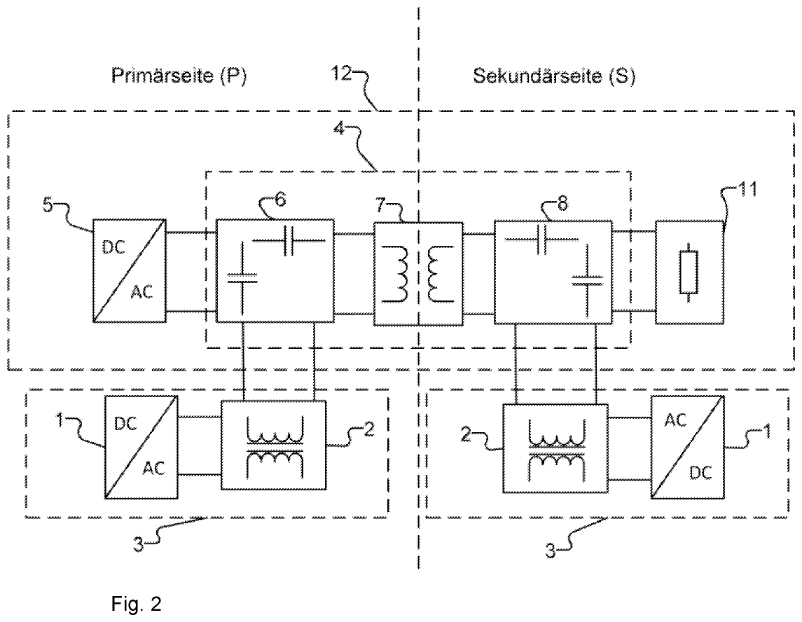

FIG. 2: shows schematically an inductive transmission system with active injection of reactive power on both sides and an AC load;

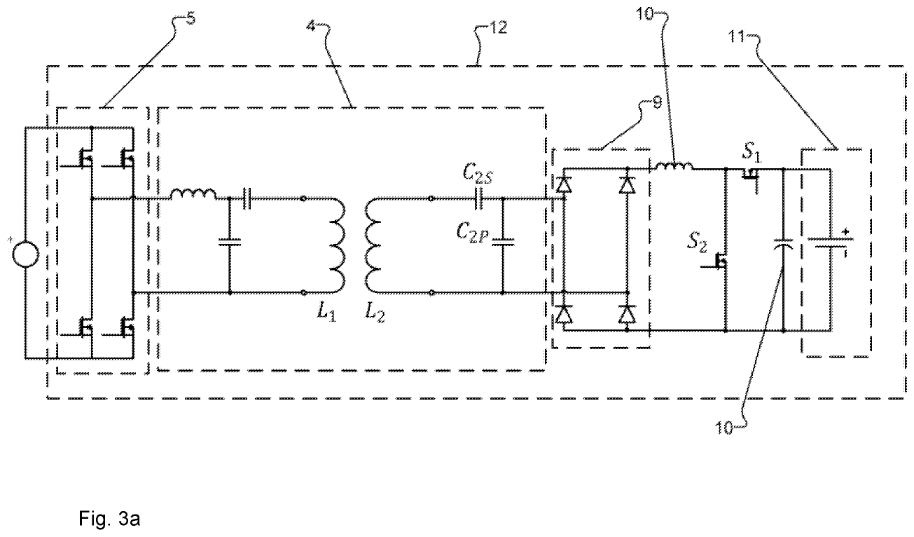

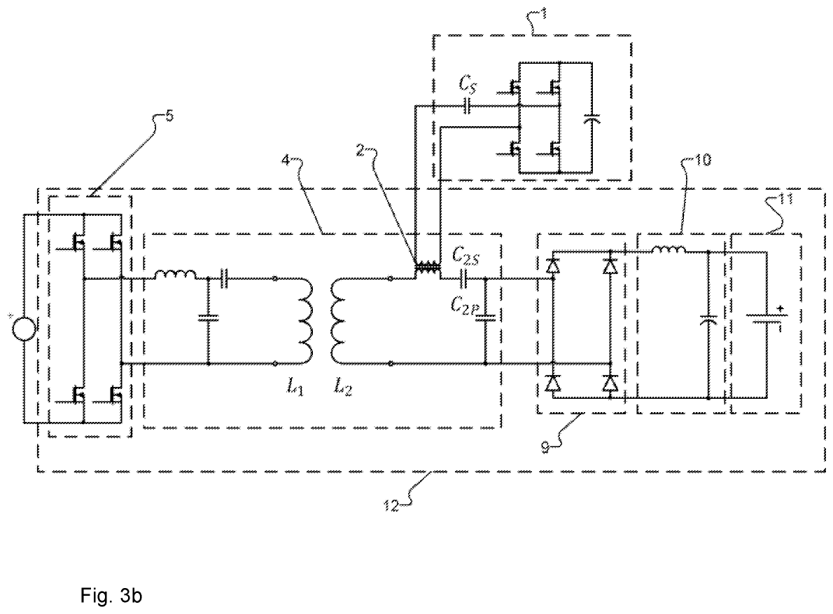

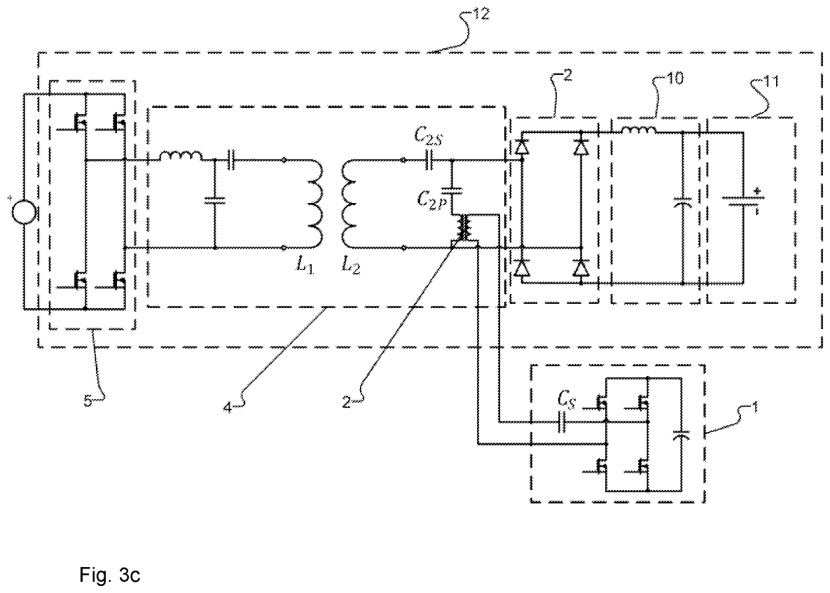

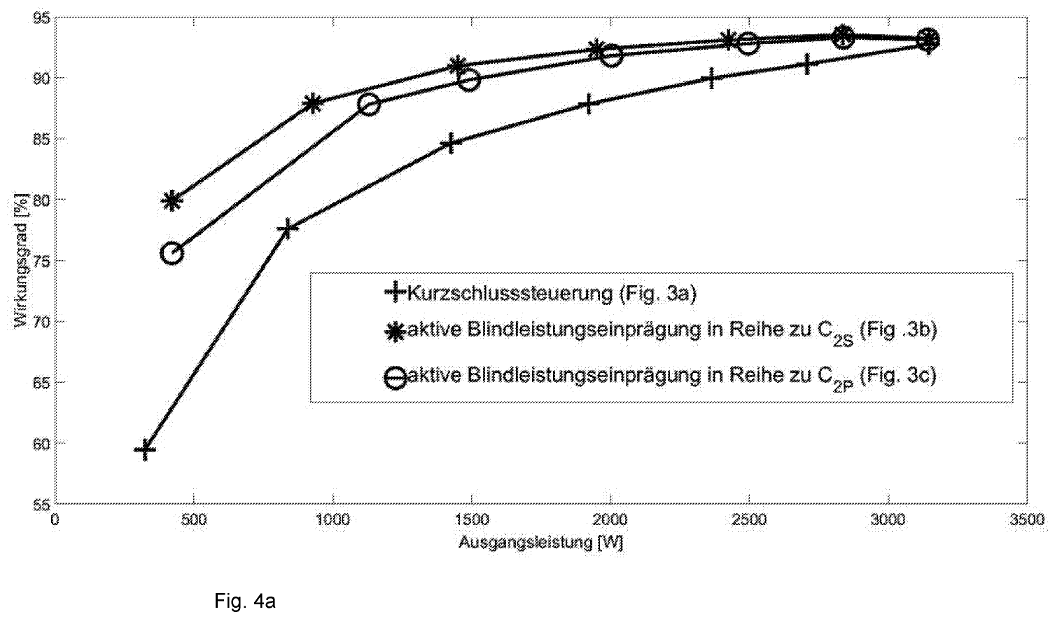

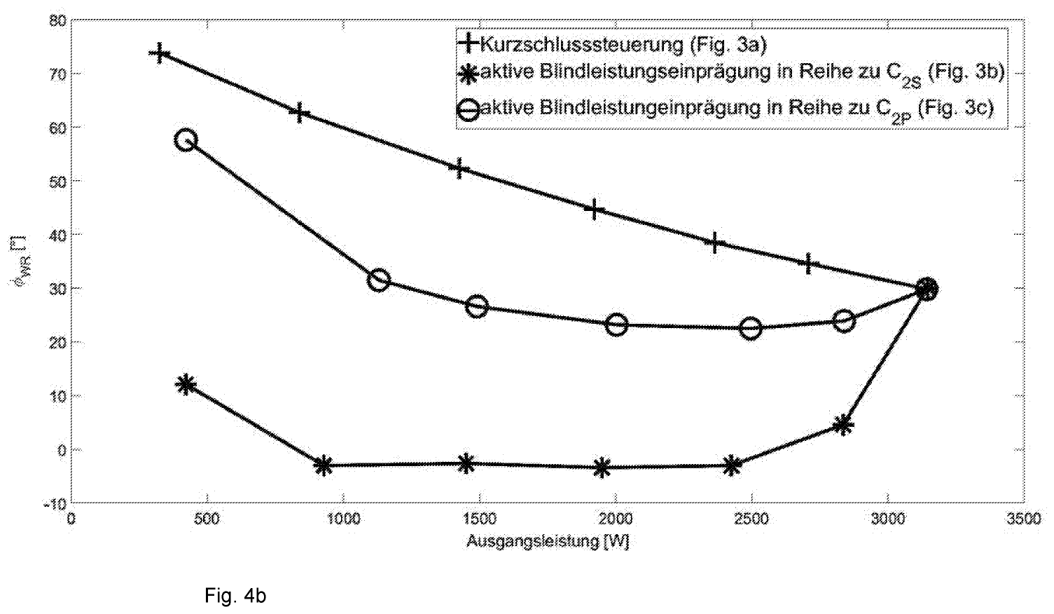

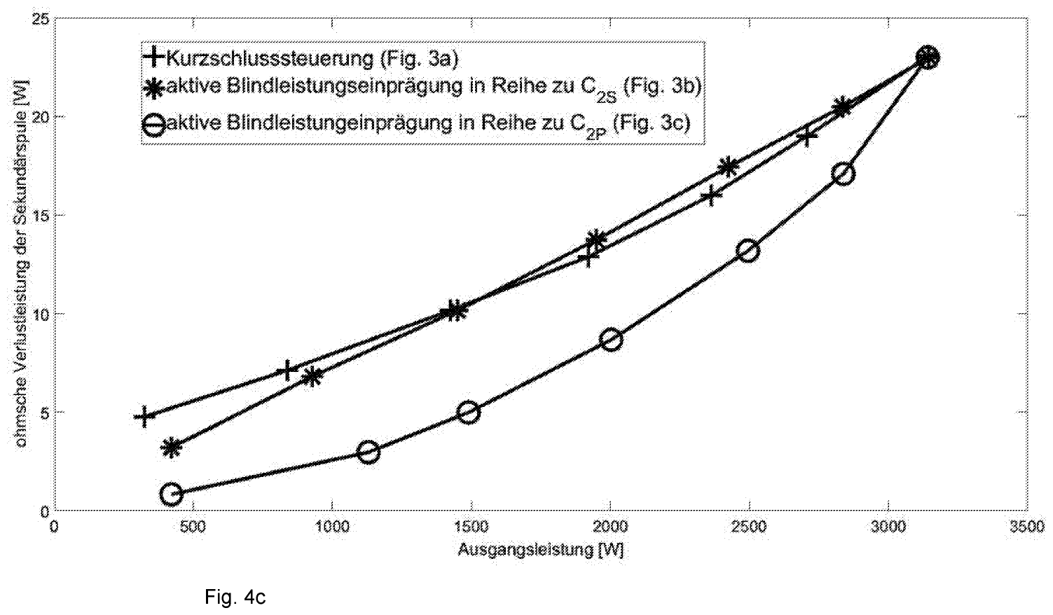

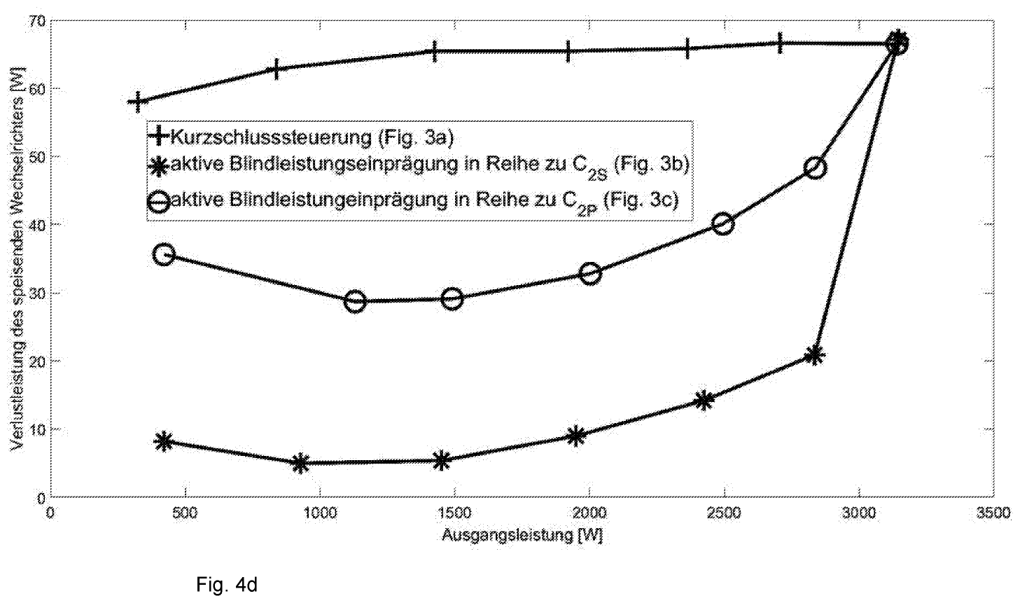

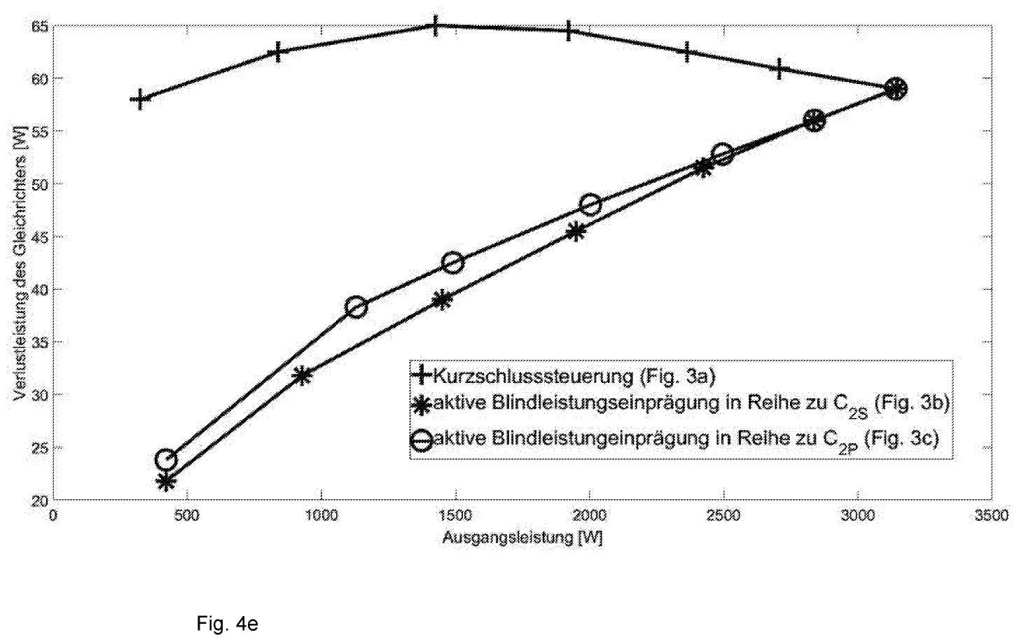

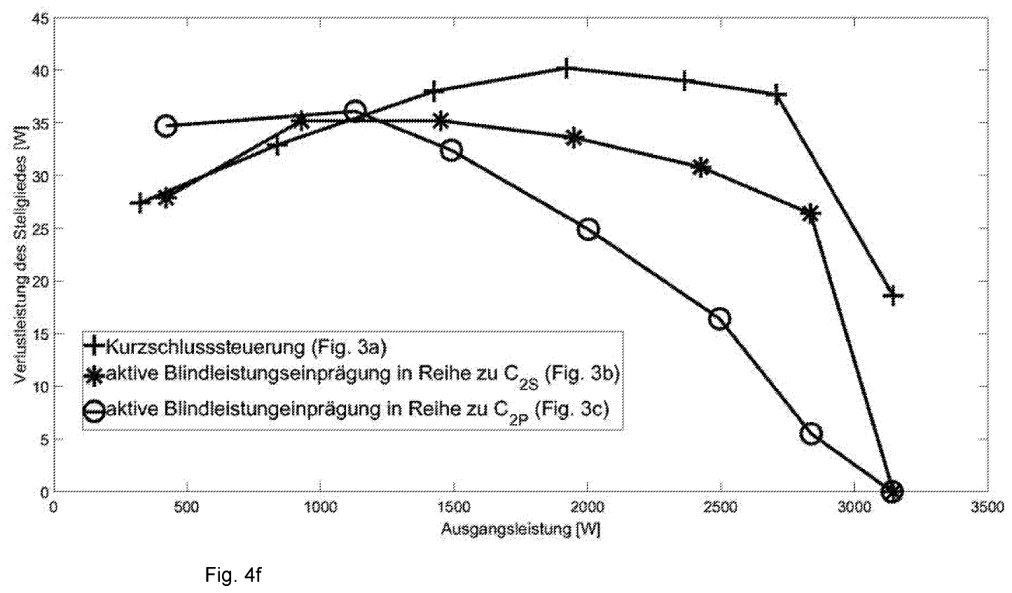

FIGS. 3a-3c: show schematically simulated topologies, as follows:

FIG. 3a: shows schematically a short circuit control;

FIG. 3b: shows schematically an active injection of reactive power in series to C_{2S};

FIG. 3c: shows schematically an active injection of reactive power in series to C_{2P};

FIG. 4a-4f: show schematically simulation results of the simulated topologies, as follows:

FIG. 4a: shows schematically the efficiency vs. the output power;

FIG. 4b: shows schematically the phase angle between the output voltage and the output current of the feeding inverter (5) vs. the output power;

FIG. 4c: shows schematically the ohmic power loss at the secondary coil (L₂) vs. the output power;

FIG. 4d: shows schematically the power loss of the feeding inverter (5) vs. the output power;

FIG. 4e: shows schematically the power loss of the rectifier (9) vs. the output power;

FIG. 4f: shows schematically the power loss of the actuator (3) according to FIG. 3b and FIG. 3c or S₁ and S₂ according to FIG. 3a vs. the output power;

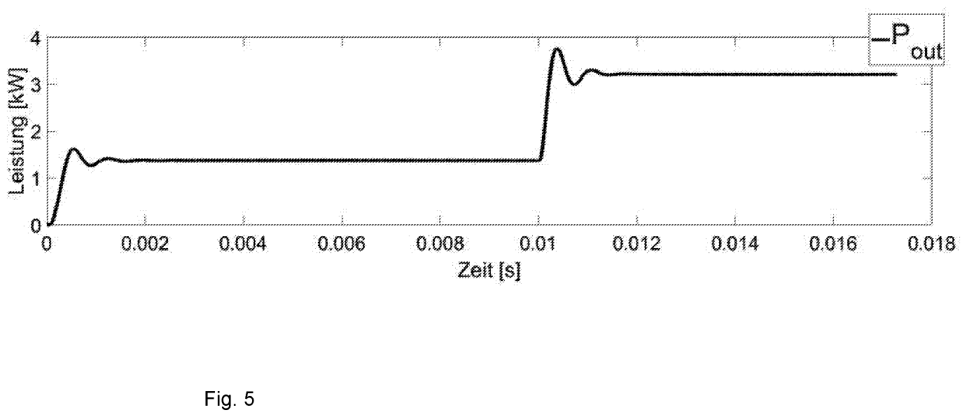

FIG. 5: shows schematically the equilibration of parameter variations during operation on the example of a variation of C_{2S} by −10% and the active injection of capacitive reactive power in series to C_{2S} according to FIG. 3b;

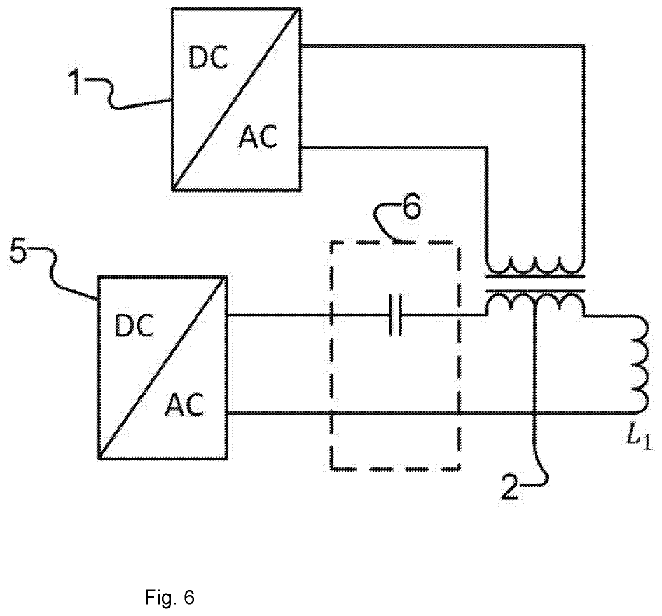

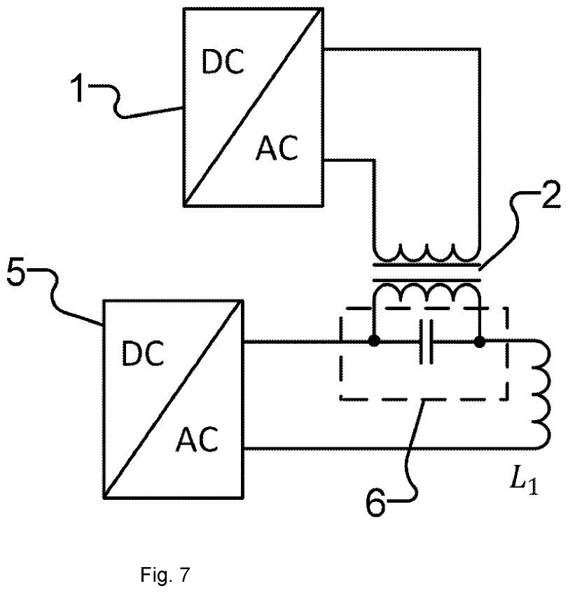

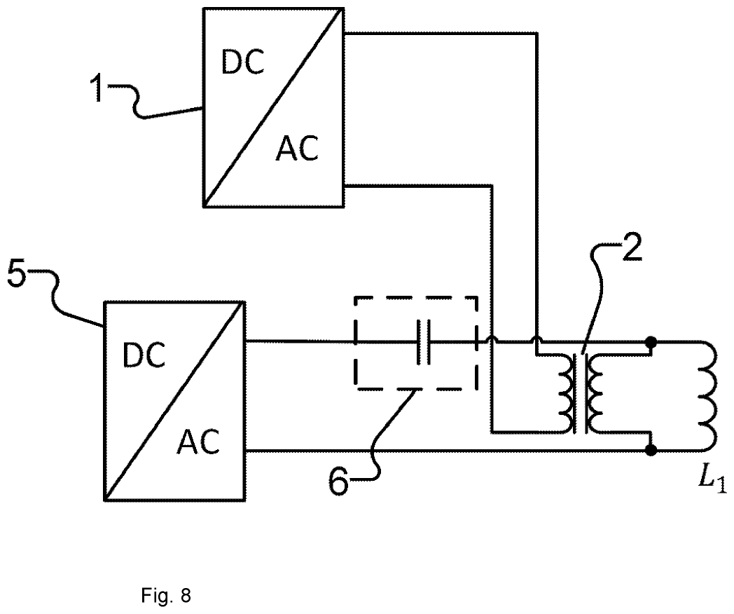

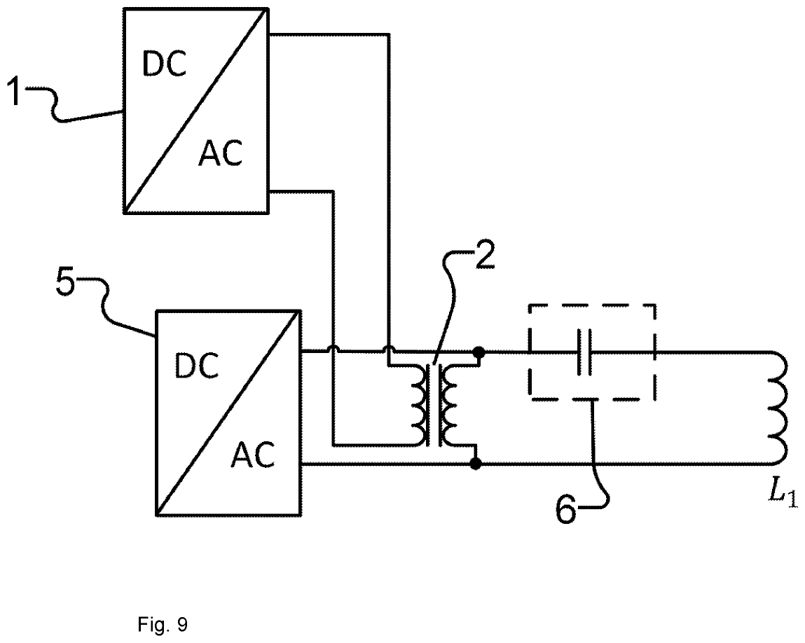

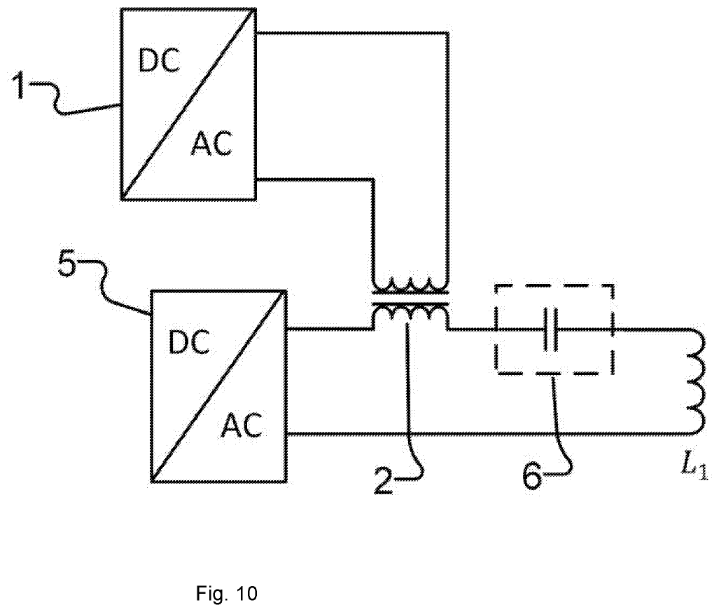

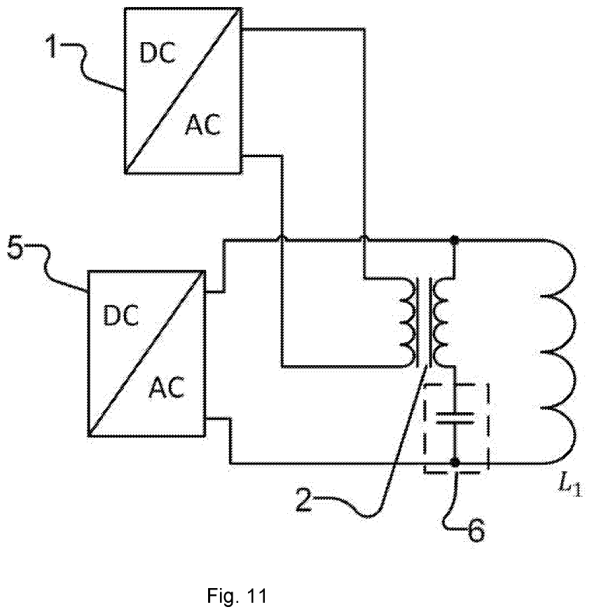

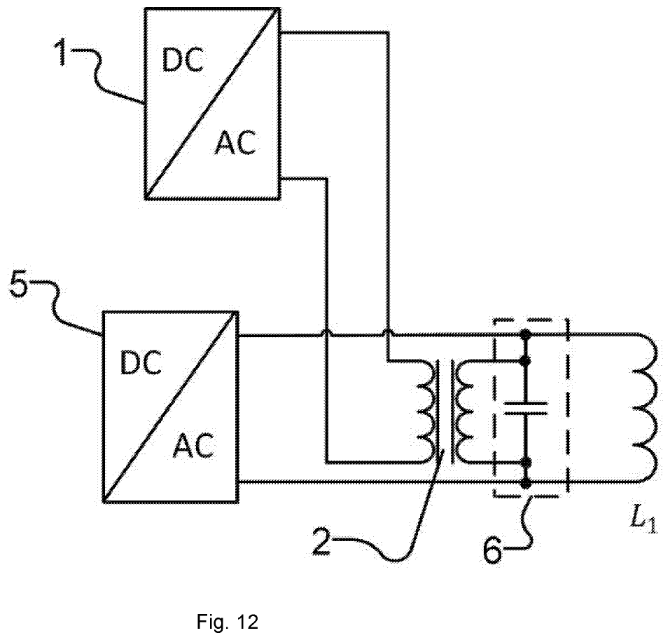

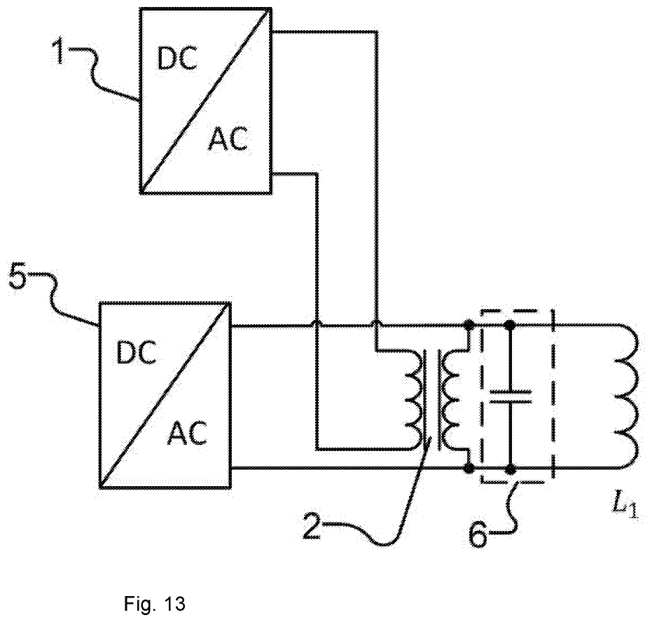

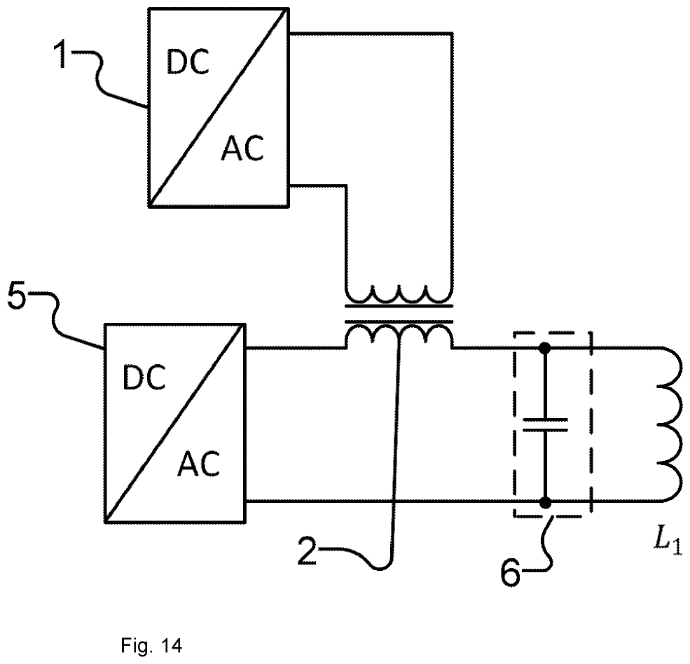

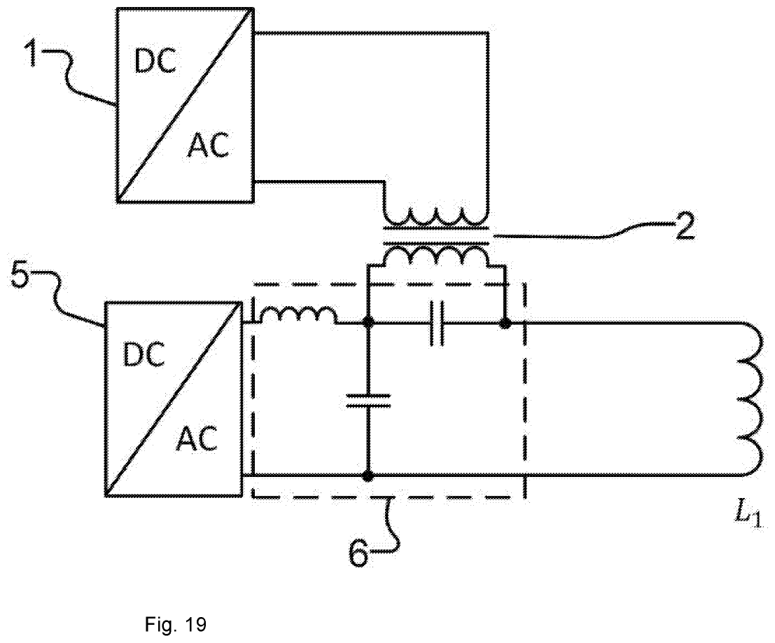

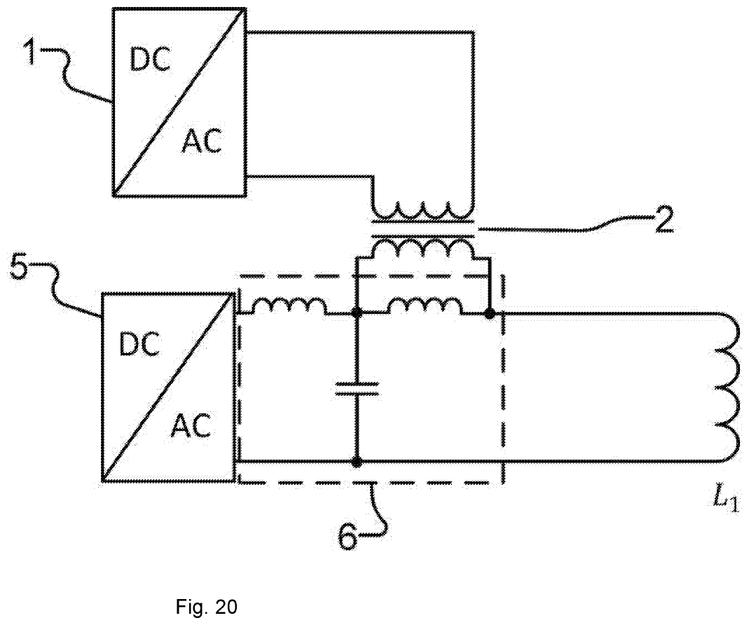

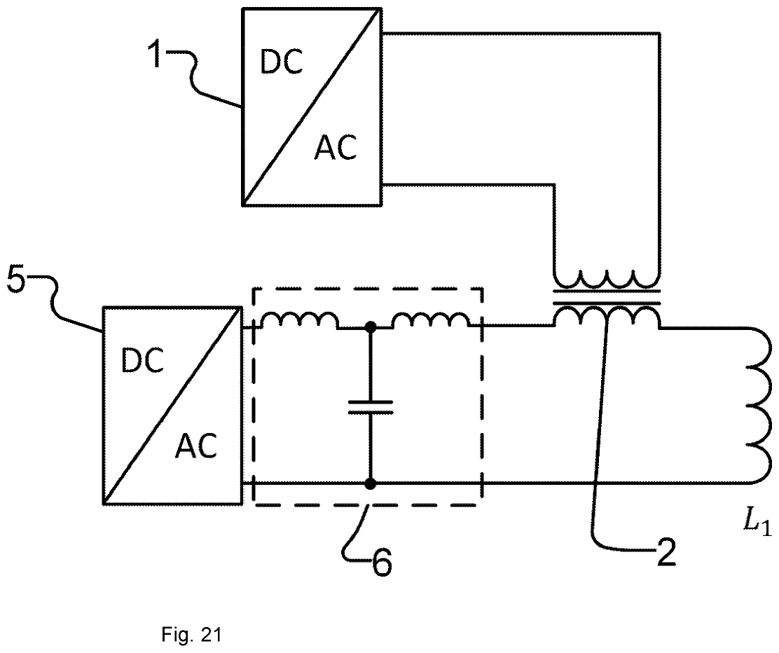

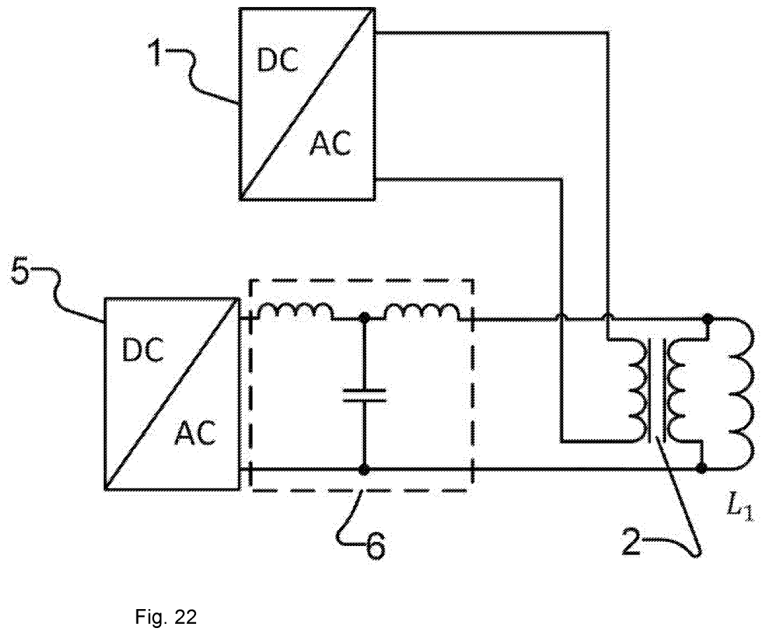

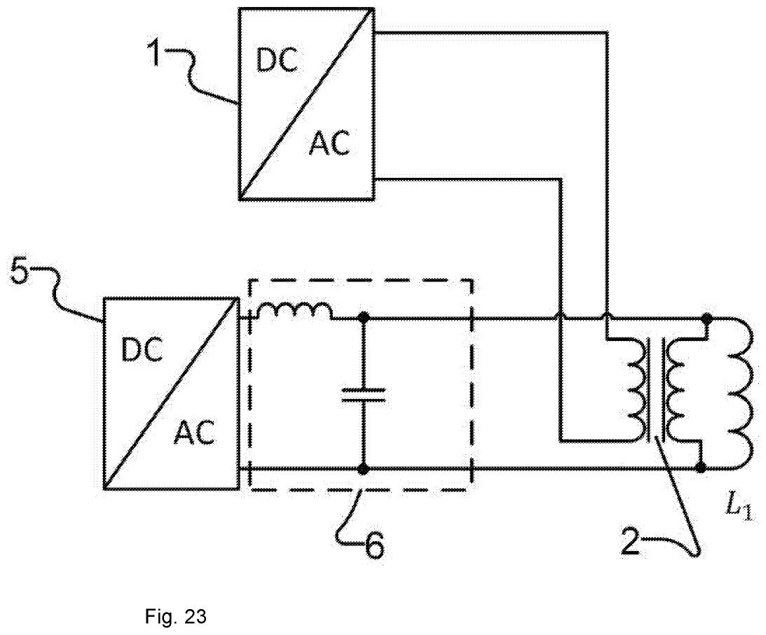

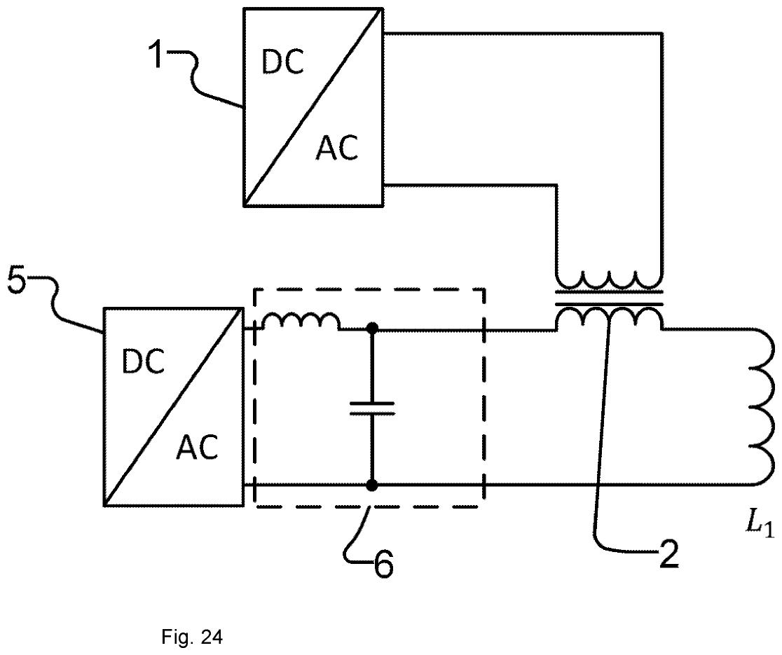

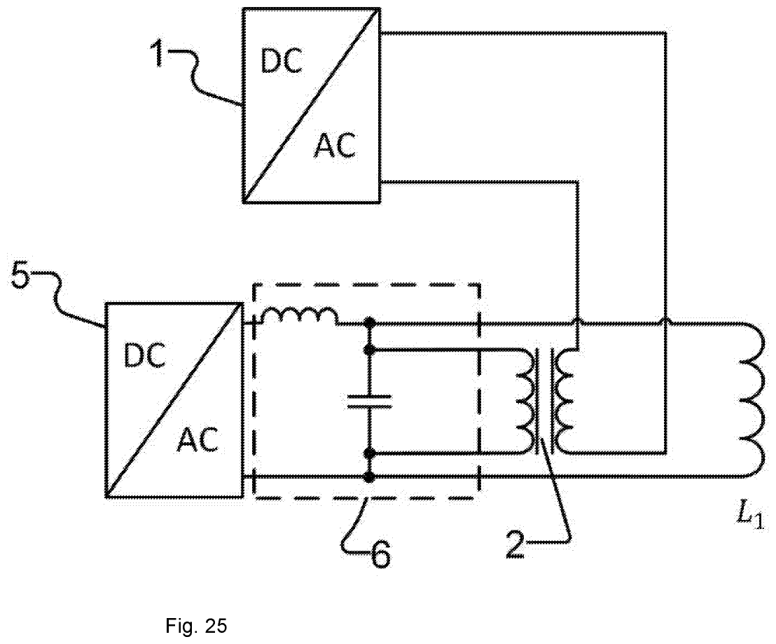

FIG. 6 to FIG. 25: show schematically different arrangements for a primary-side active injection of reactive power;

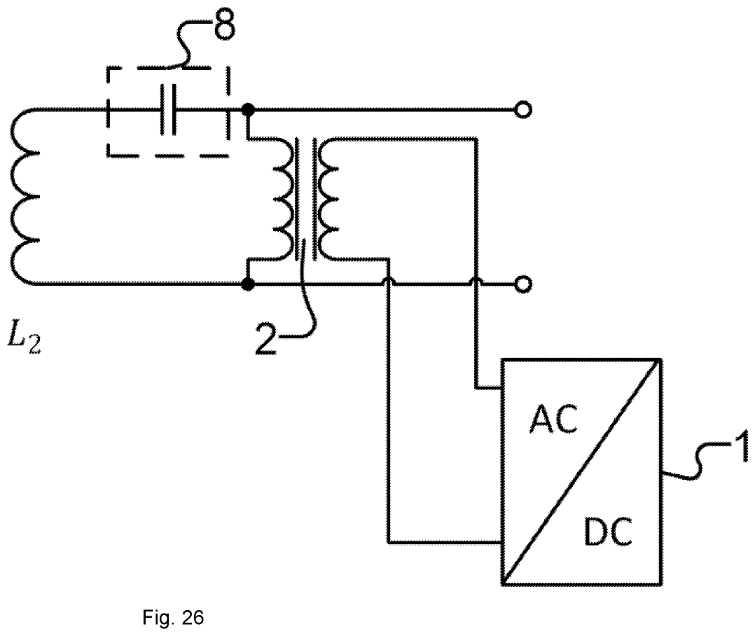

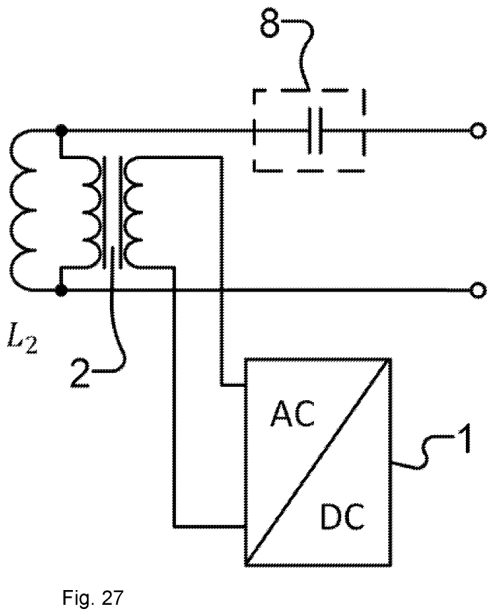

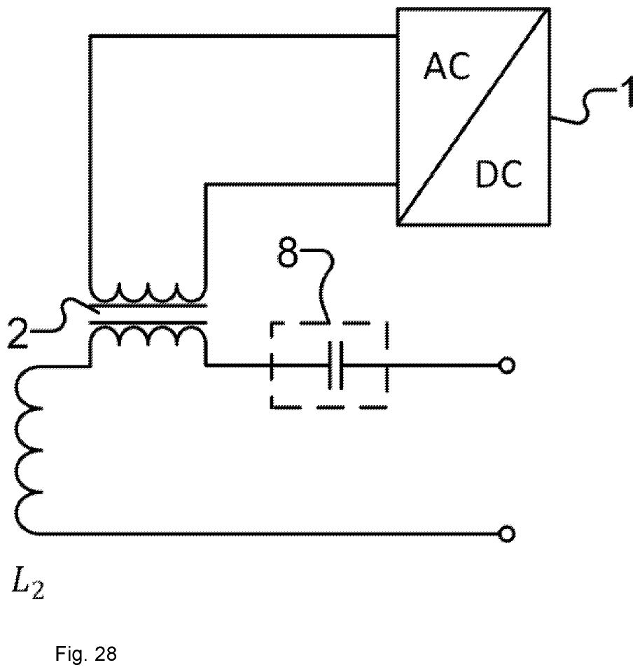

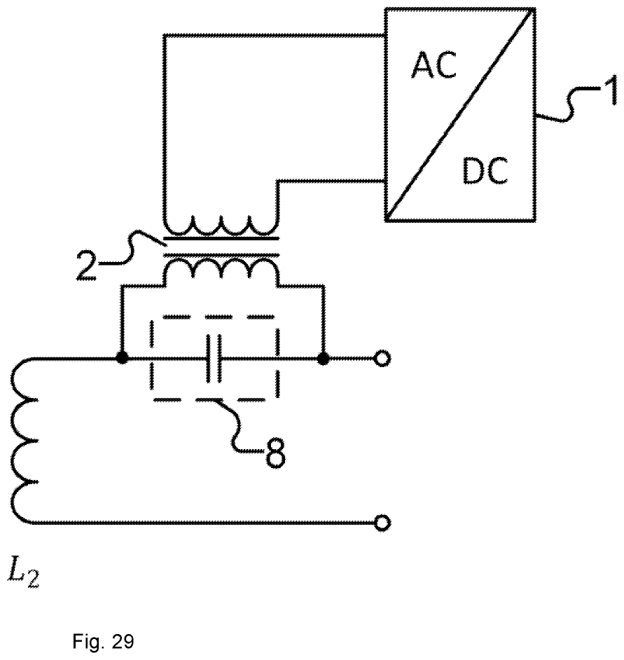

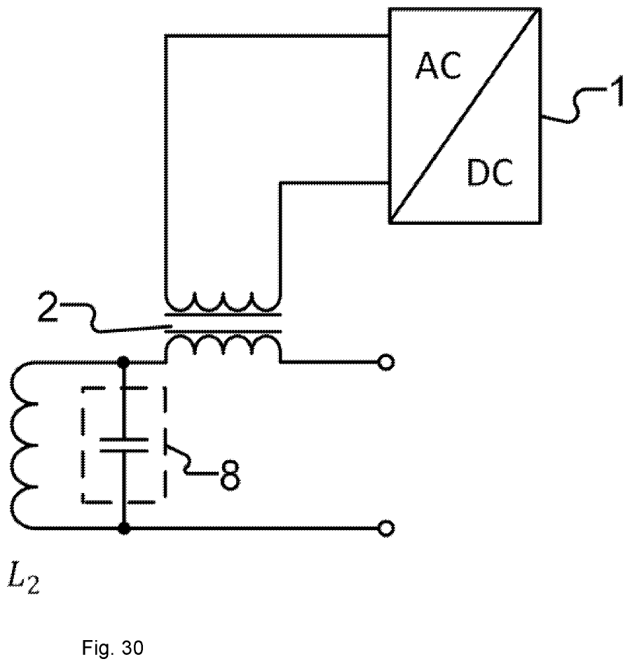

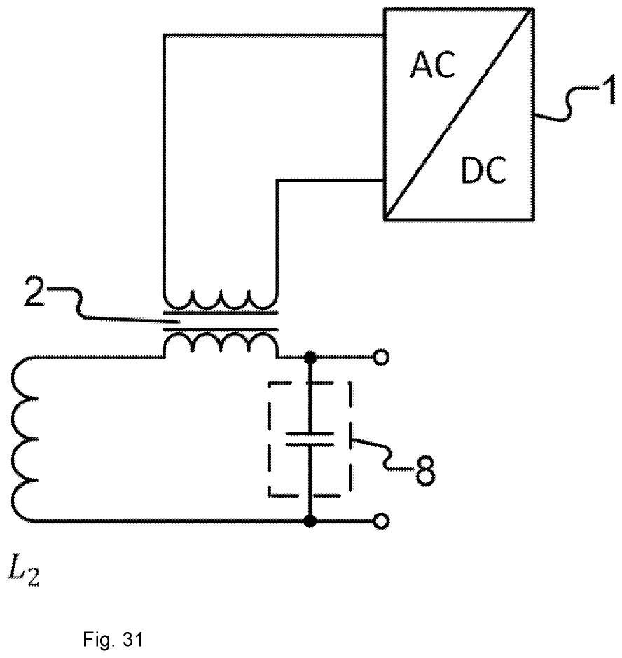

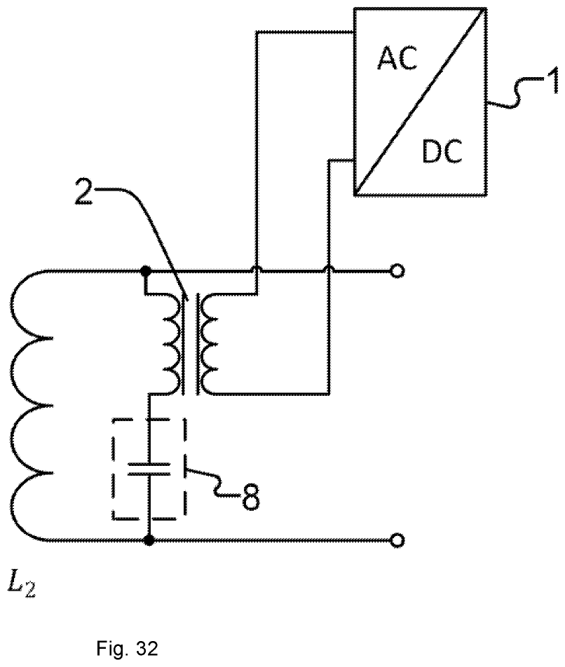

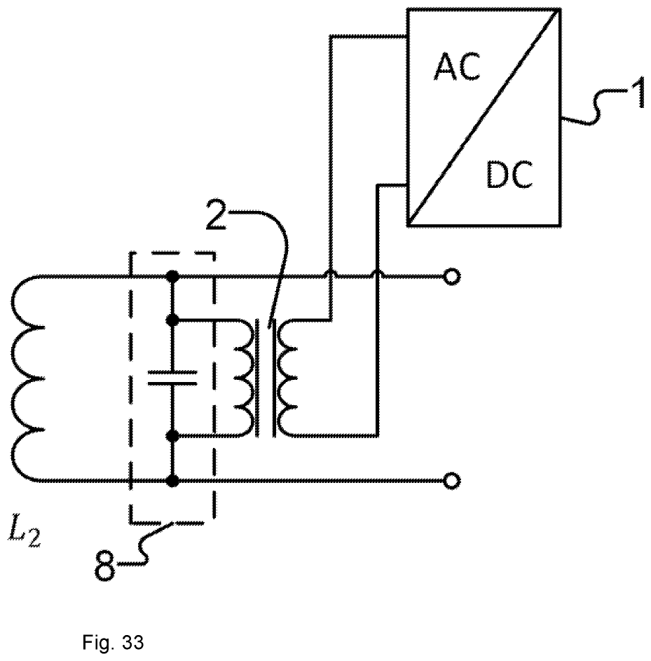

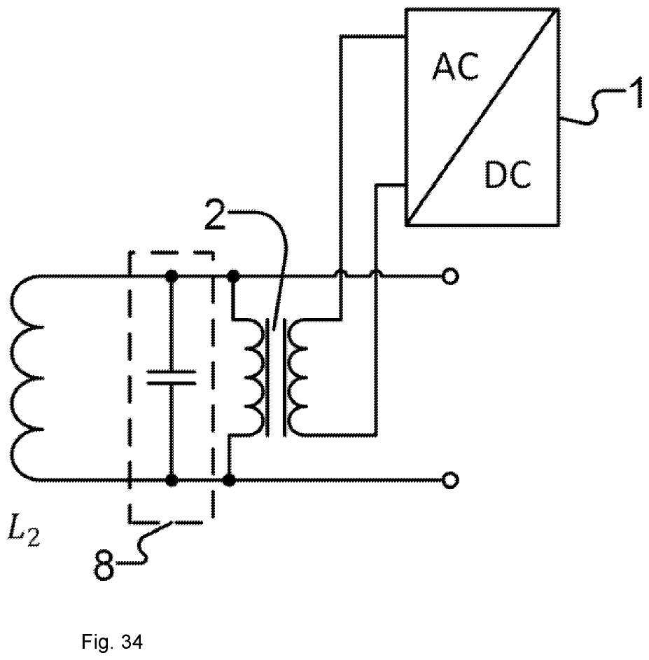

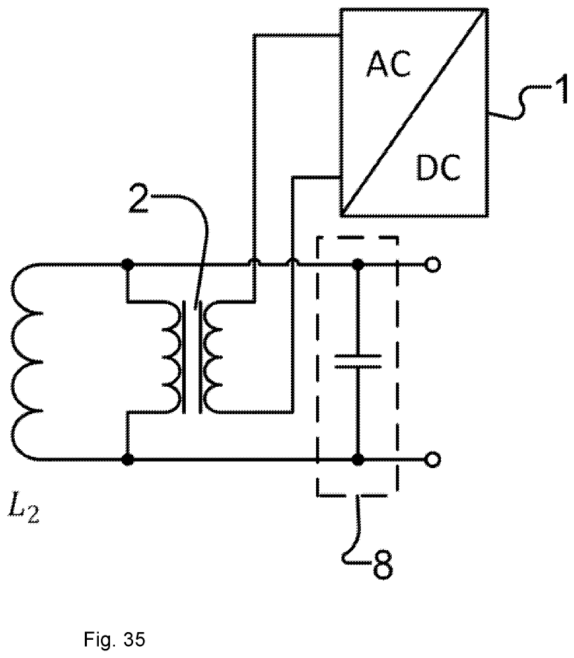

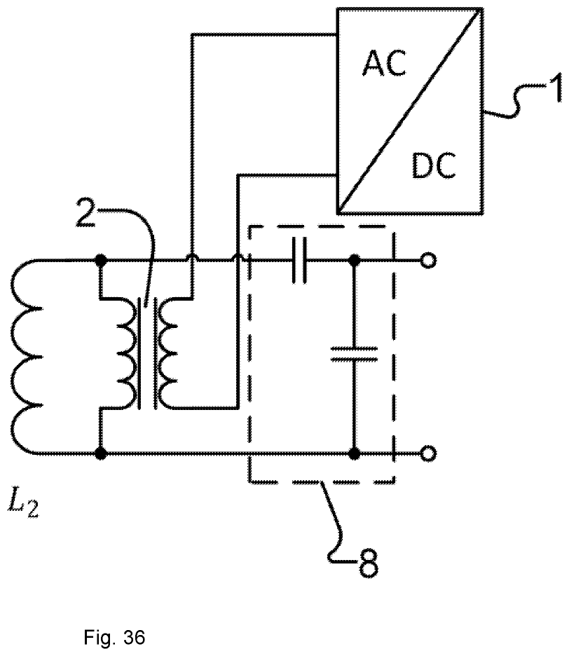

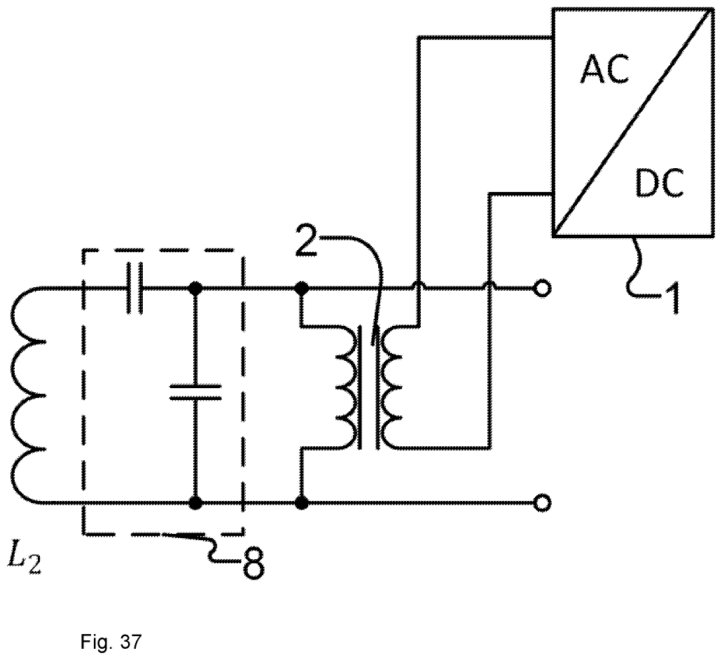

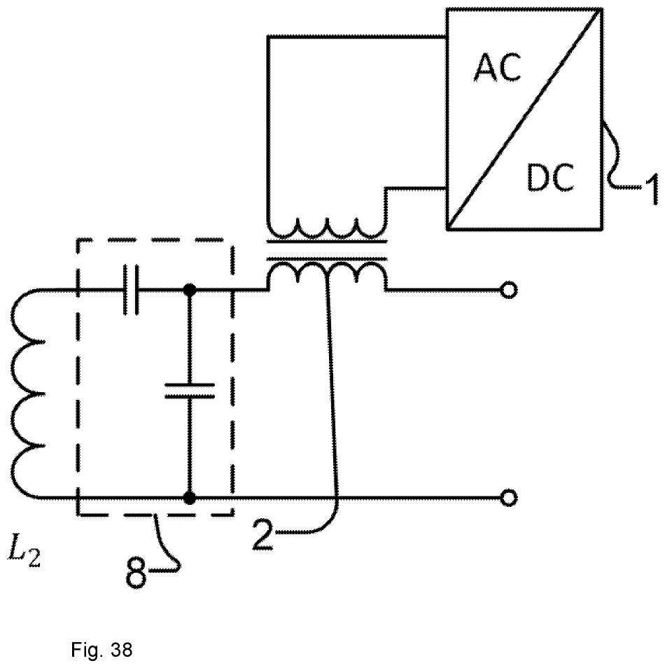

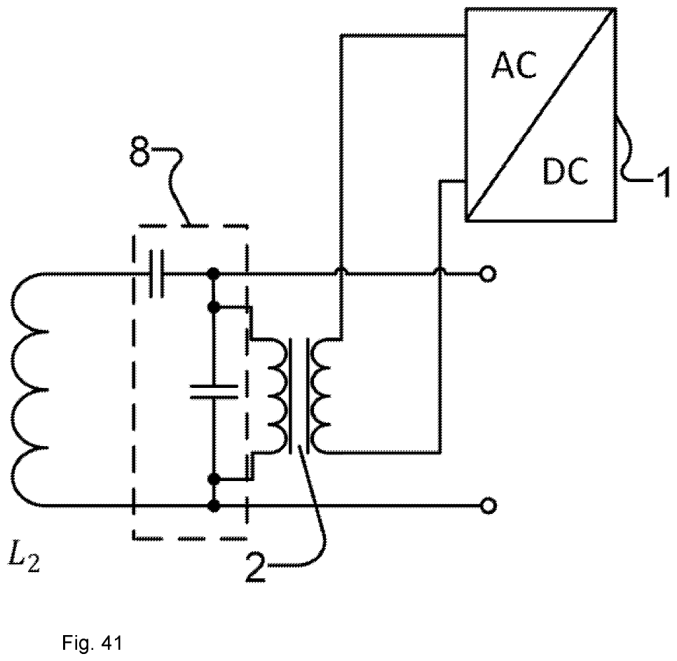

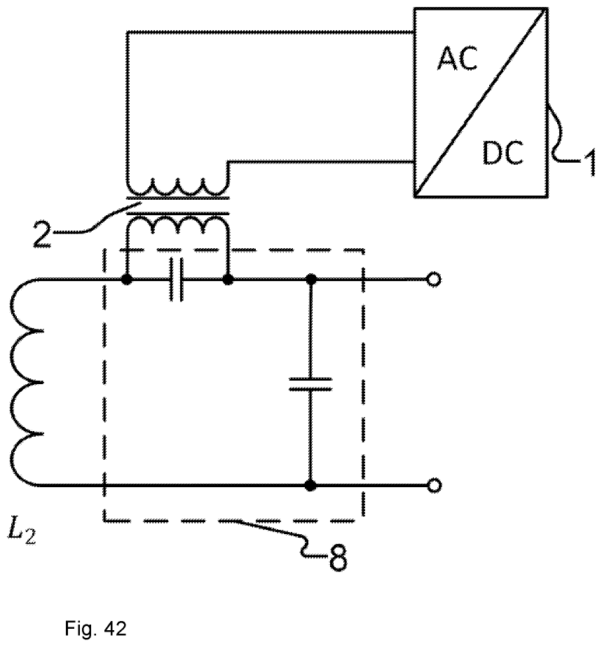

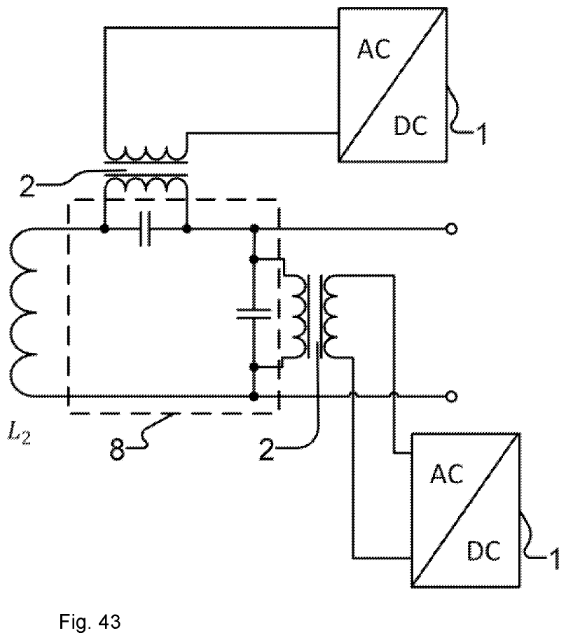

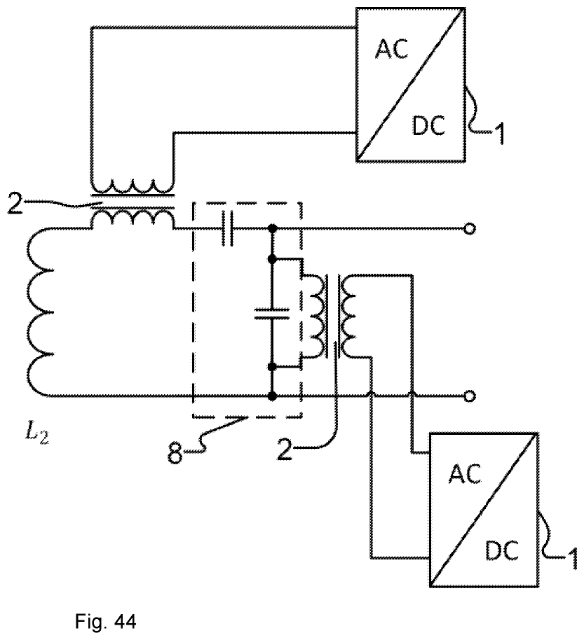

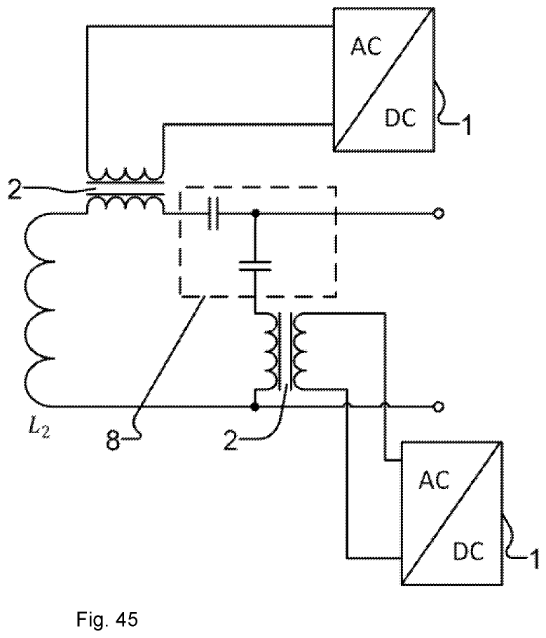

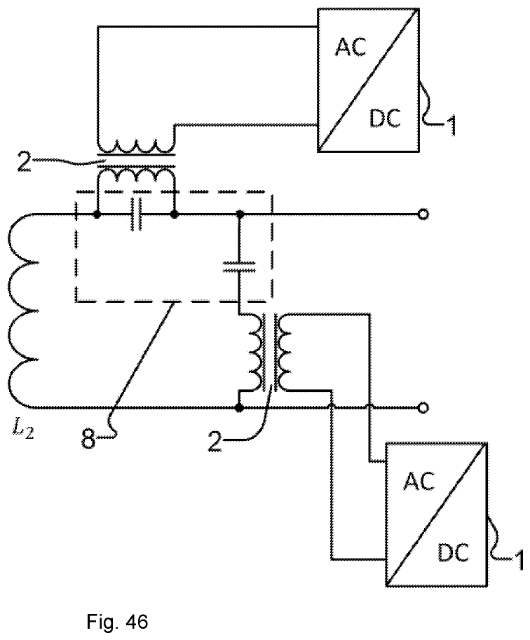

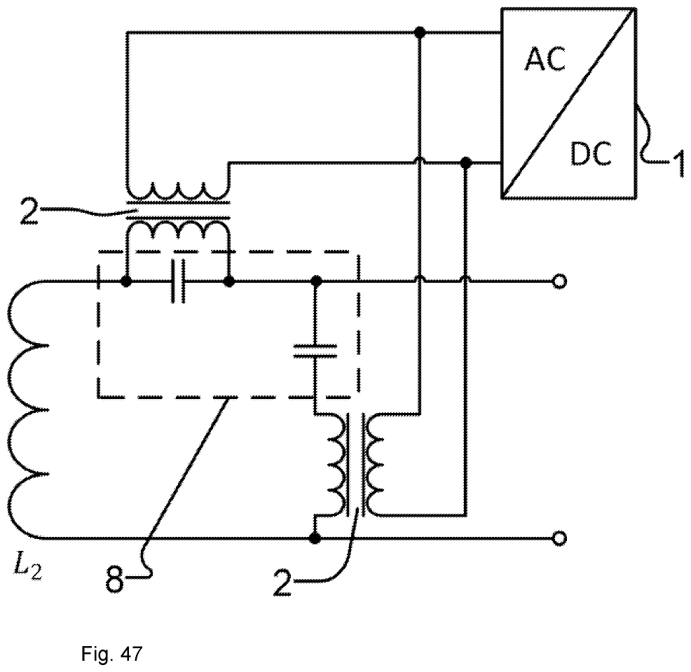

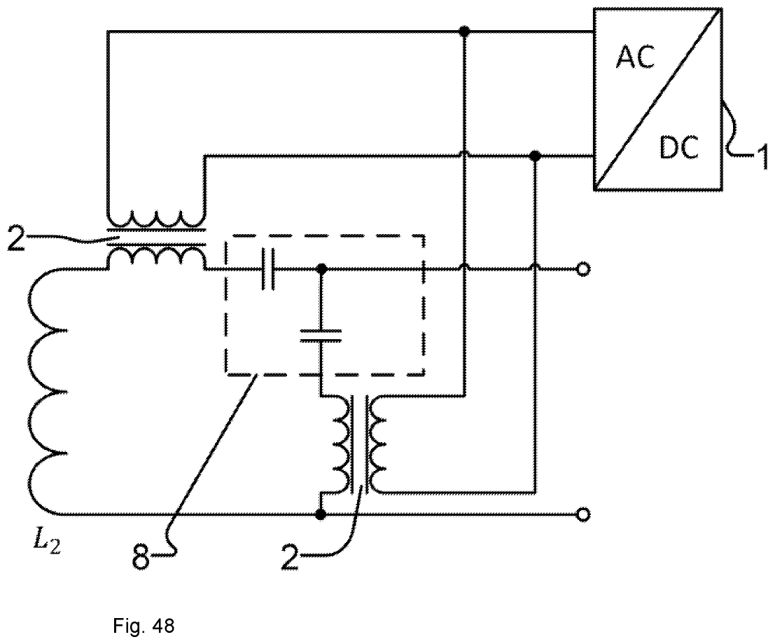

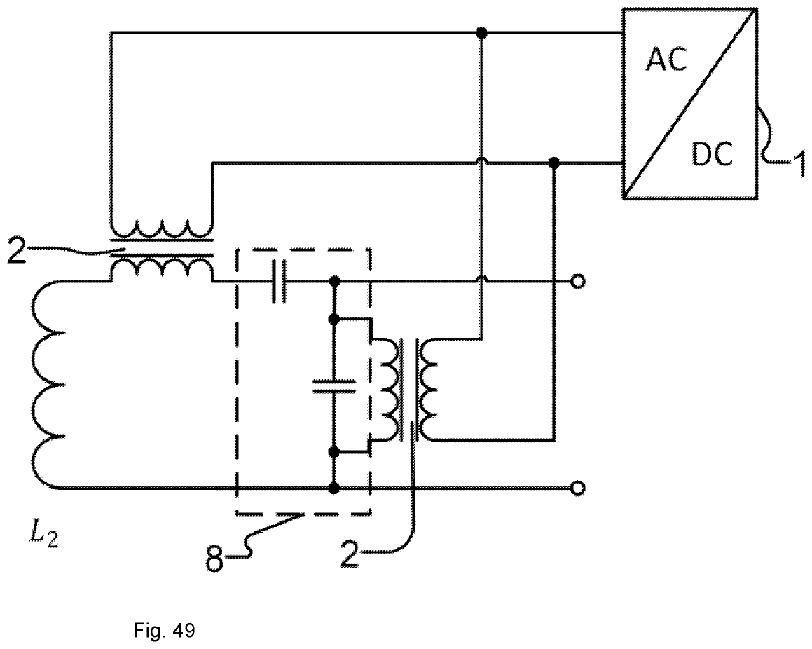

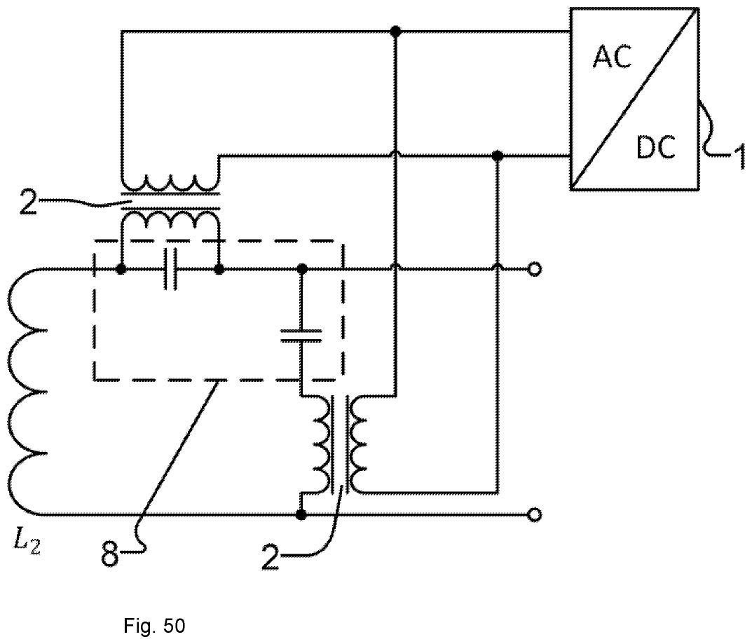

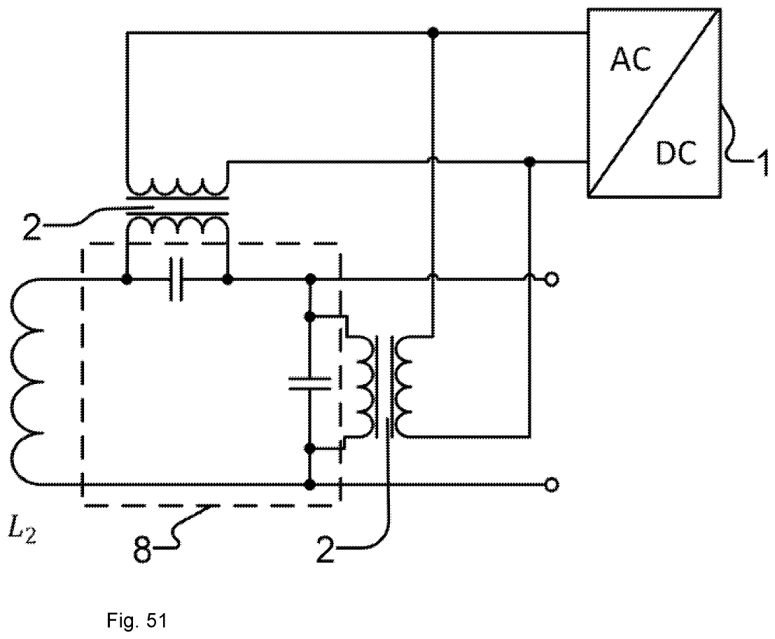

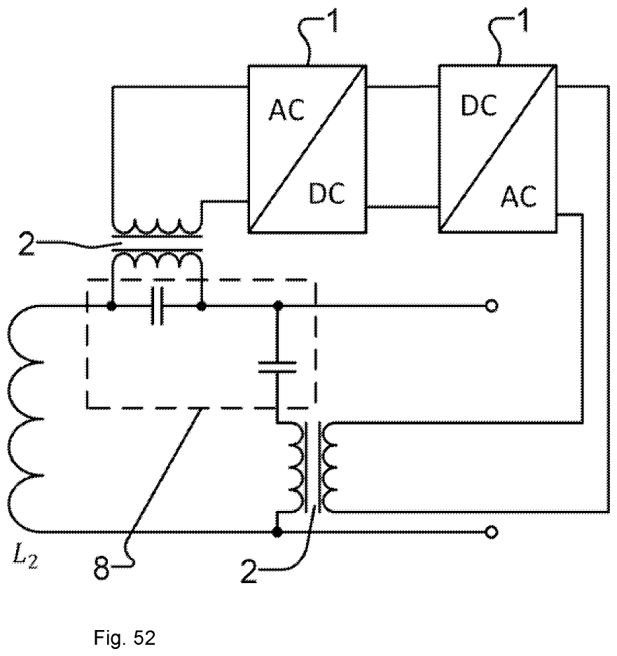

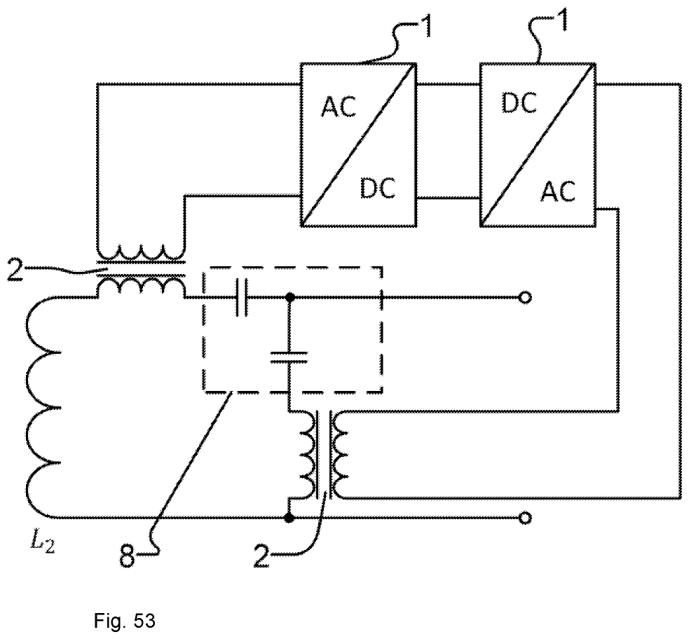

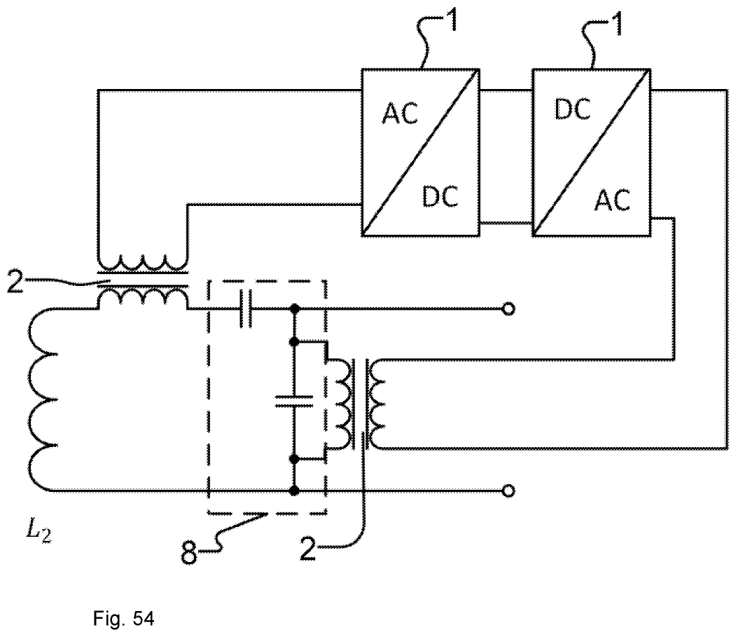

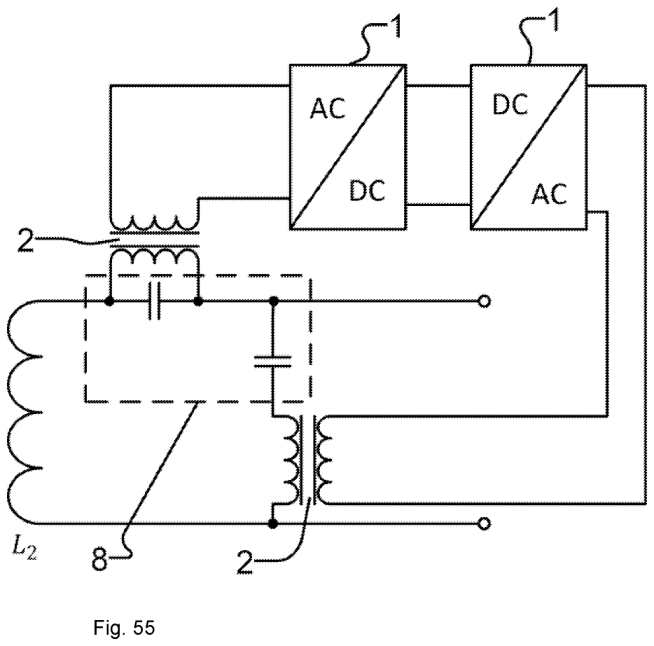

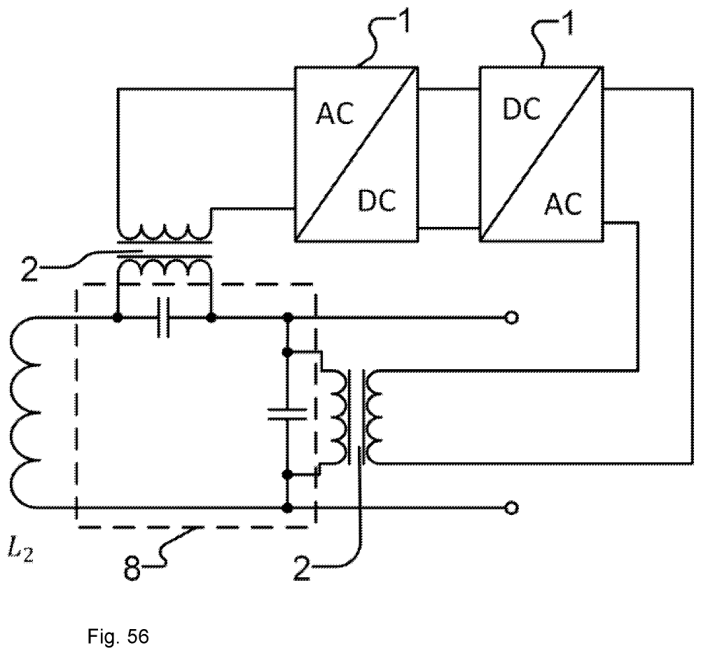

FIG. 26 to FIG. 56: show schematically different arrangements for a secondary-side active injection of reactive power; and

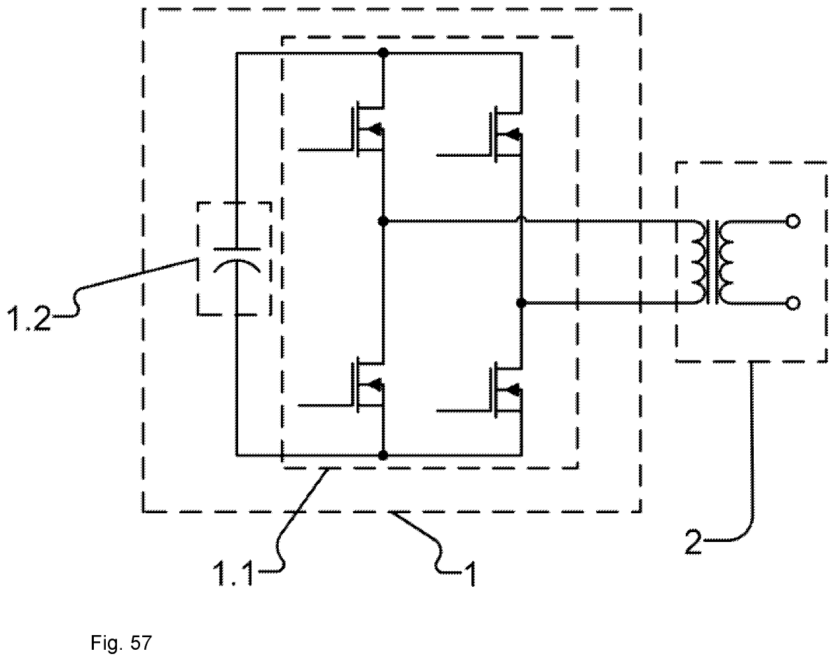

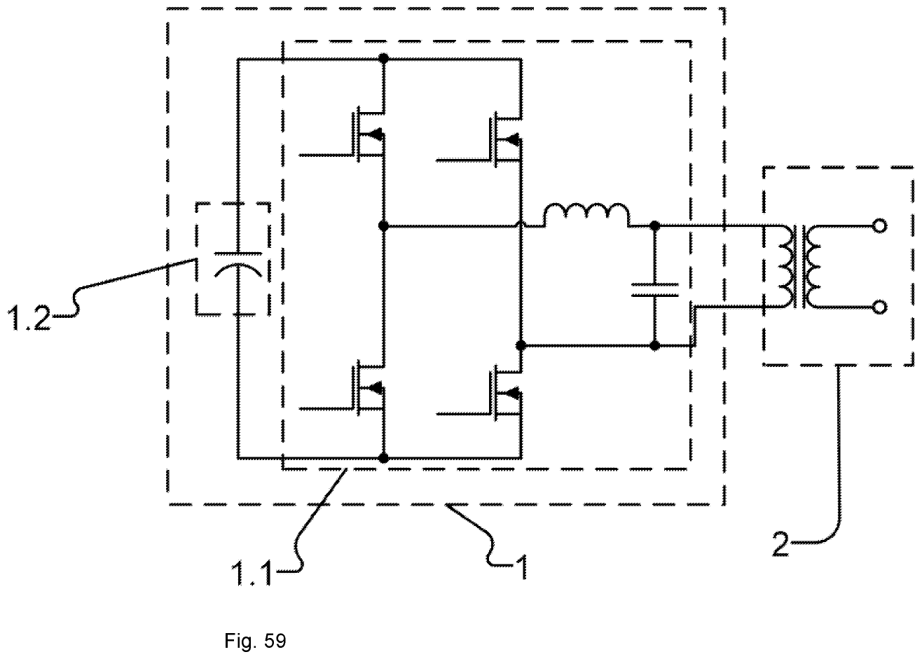

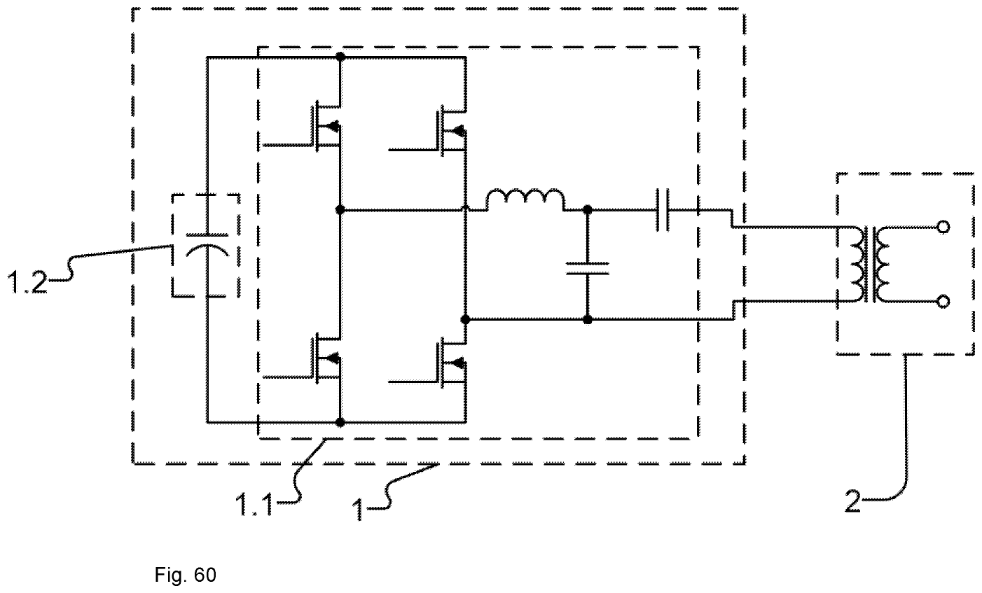

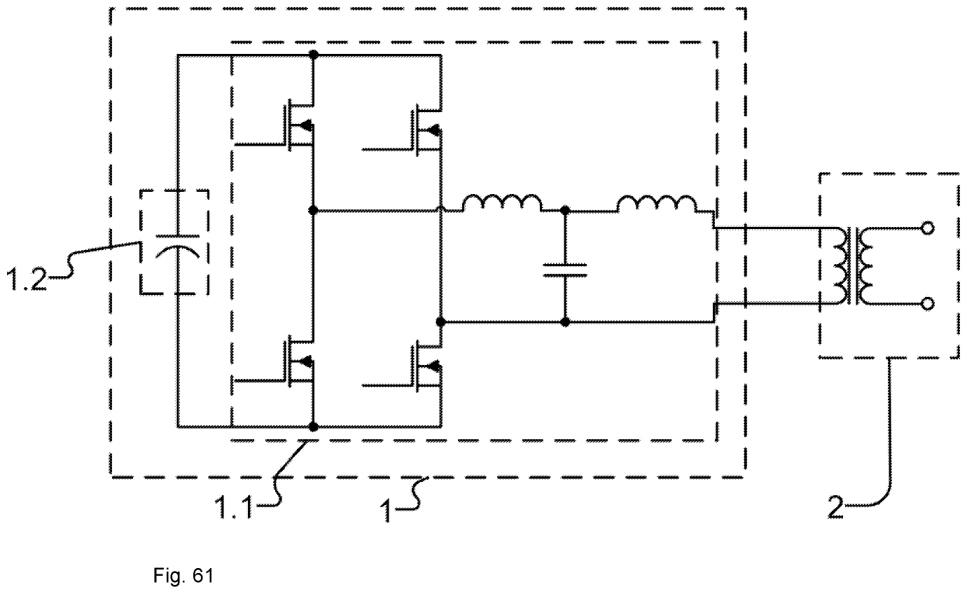

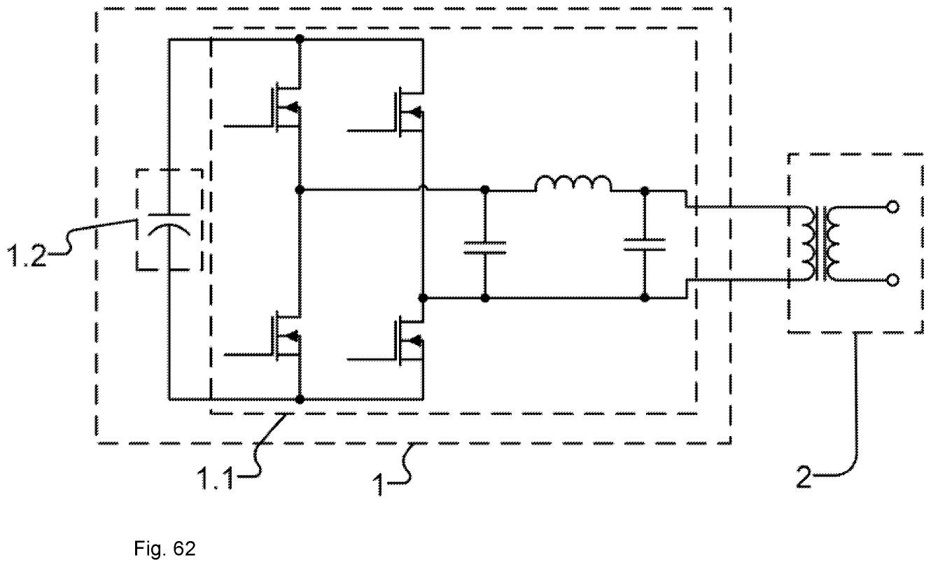

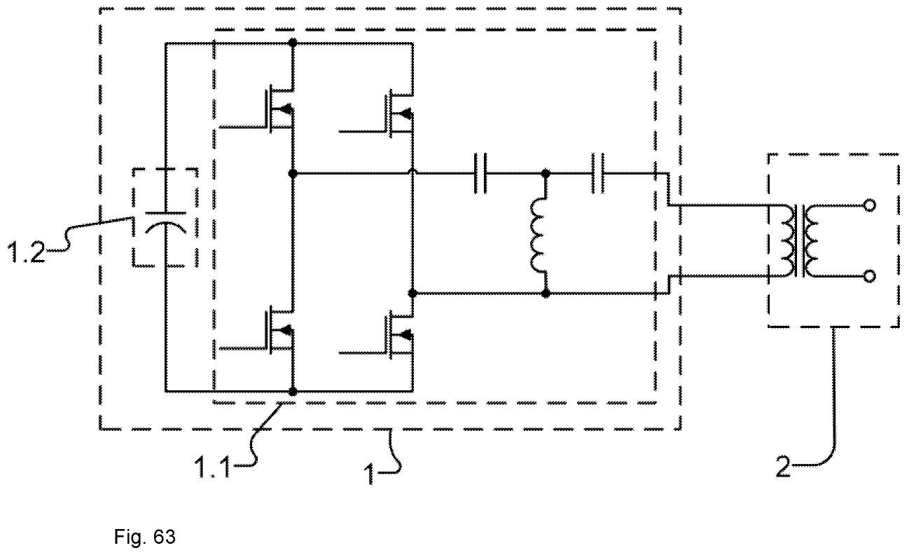

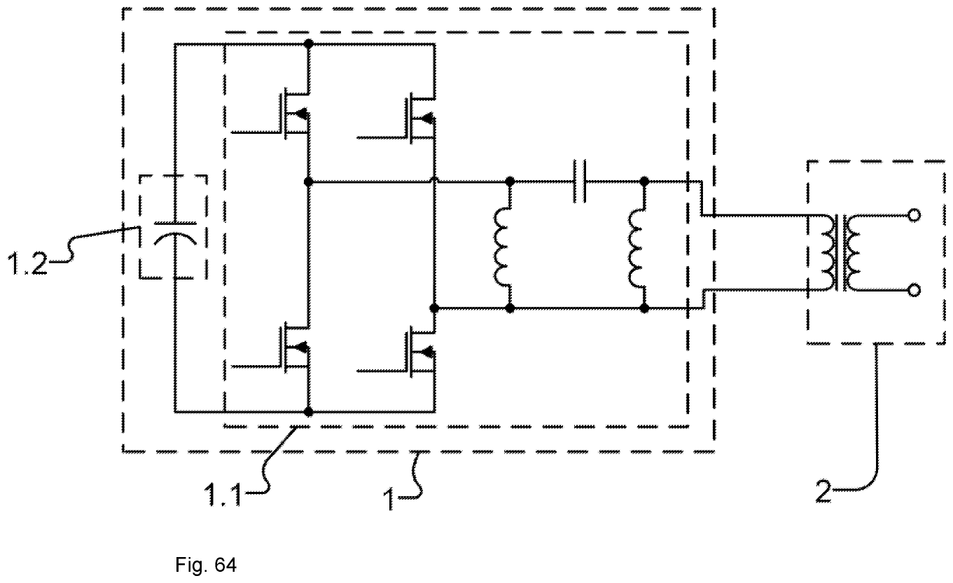

FIG. 57 to FIG. 64: show schematically different possibilities for realizing active generation of reactive power.

FIG. 1 shows schematically an exemplary inductive transmission system (12) with active injection of reactive power (3) on both sides and a DC load (11). The inductive transmission system (12) is assembled from the feeding inverter (5), the compensated coil system (4), the rectifier (9), the output filter (10), and a DC consumer (11). The compensated coil system in this case is composed of the primary-side compensation (6), the coil system (7) and the secondary-side compensation (8). The apparatus (3) for active injection of reactive power shown on both sides is assembled in each case from the device (1) for reactive power generation as well as the device (2) for coupling in reactive power. By generation and coupling-in a reactive power, the compensation of the inductive transmission system can be varied with the schematically shown exemplary embodiment.

The intermediate energy store necessary for the reactive power generation in this case can be fed in both from the transmission system by operating the device for the reactive power generation in rectifier operation, or from an additional energy source. For example, in one application for inductive battery charging in electric mobility, the secondary-side device for reactive power generation could be fed from the battery via another DC/DC converter. Likewise, the primary-side device for the reactive power generation could be fed from the intermediate energy store of the feeding inverter via an additional DC/DC converter.

Feeding the device for reactive power generation from an additional energy source offers here the advantage of additionally being able to also feed effective power into the inductive transmission system for the injection of reactive power, so that another degree of freedom results. Opposed to this, there is the disadvantage that more components are required, for which reason the required structural size and the system costs will increase.

Analogous to FIG. 1 FIG. 2 shows schematically an exemplary inductive transmission system (12) with active injection of reactive power (3) on both sides and an AC load (11). Based on the AC consumer (11), in this diagram, the rectifier and the output filter are omitted, so that the inductive transmission system (12) that is shown is composed of the feeding inverter (5), the compensated coil system (4), and the AC consumer (11).

The compensated coil system here is composed of the primary-side compensation (6), the coil system (7) and the secondary-side compensation (8). The apparatus for the active injection of reactive power (3) shown on both sides is assembled in each case from the device (1) for reactive power generation as well as the device (2) for coupling in reactive power. By generating and coupling in a reactive power, with the schematic diagram shown, the compensation of the inductive transmission system can be varied.

The intermediate energy store necessary for the reactive power generation can be fed in here both from the transmission system as well as from an additional energy source. Exemplary applications for the schematic diagram shown with AC load are found in the contact-free supplying of electric drives, such as, for example, for the contact-free supplying of driverless transport systems in intralogistics or the contact-free injection of a current into the excitation winding of an externally excited synchronous machine.

### Simulation Investigations:

By way of example, simulations based on two embodiments of the active injection of reactive power are shown, which are based on a model of an actual inductive charging system. Actual, procurable structural components were employed for calculating loss. A comparison was made with the prior art in order to demonstrate the higher efficiency in the partial load region due to a targeted detuning of the balance.

Table 1 lists the system parameters and the structural components that are the basis for the loss calculation. FIGS. 3a-3c show the simulated circuit topologies and FIGS. 4a-4f show the processed simulation results. The short circuit control was calculated with the design of the short circuit switch as a synchronous converter and PWM control for representing the prior art, the active injection of reactive power as a new innovative actuator in series for serial compensation and in series for parallel compensation. In this case, H bridges are found in the rectifier operation, by which the device is fed from the transmission system for the active generation of reactive power.

The variable reactive power is generated by means of phase-shift actuation. Here, both capacitive as well as inductive reactive power are generated and coupled in.

By decoupling the active actuator from the transmission system, the component load and the losses of the power electronics clearly decrease. The fixed-coupled transformer was dimensioned so that the voltage of the H bridges is a maximal 400 V, so that loss-poor 600 V MOSFETs can be employed. The clock frequency of the actuators was set equal to the transmission frequency.

TABLE 1
System parameters

| Rated power | 3.3 | kW |
|---|---|---|
| Transmission frequency | 140 | kHz |
| Rated coupling | 0.192 | |
| Serial capacitor of the reactive | 100 | nF |
| power generation Cₛ | | |

| | |
|---|---|
| MOSFETs employed | IPP60R017C7 T0-247-4 |
| Diodes used | VS-EBU15006HF4 |

In each of FIGS. 3a to 3c, the simulated inductive transmission system (12) is shown schematically. Analogously to FIG. 1, this system is assembled each time from the feeding inverter (5), the compensated coil system (4), the rectifier (9), the output filter (10), and the DC load (11).

The transmission system shown involves a system with primary-side current injection and secondary-side parallel compensation, wherein—for adaptation of the secondary-side current/voltage ratio—the parallel compensation capacitor was divided into a serial compensation capacitor C_{2S} and a parallel compensation capacitor C_{2P}. Based on this resonance topology, the inductive transmission system on the output side behaves approximately as an ideal current source.

Therefore, the output values are regulated with the adjusting principle shown in FIG. 3a (short circuit control). Here, the load is short-circuited as soon as S₂ is turned on, so that the output current does not flow back into the load, but rather into the resonance circuit, so that the output power can be limited. This adjusting principle corresponds to the prior art for secondary-side regulation of inductive transmission systems.

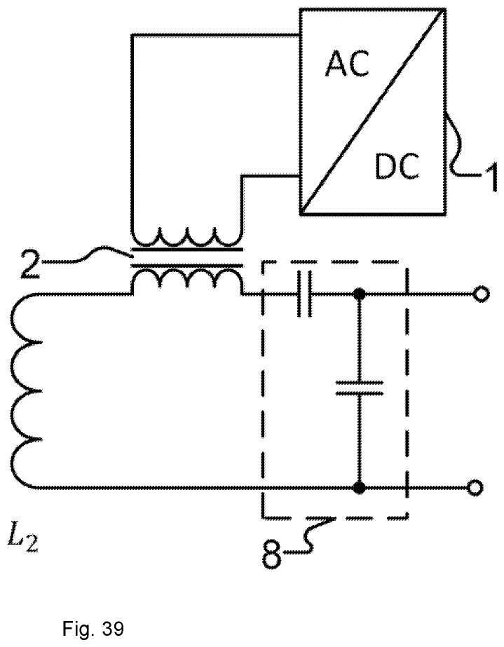

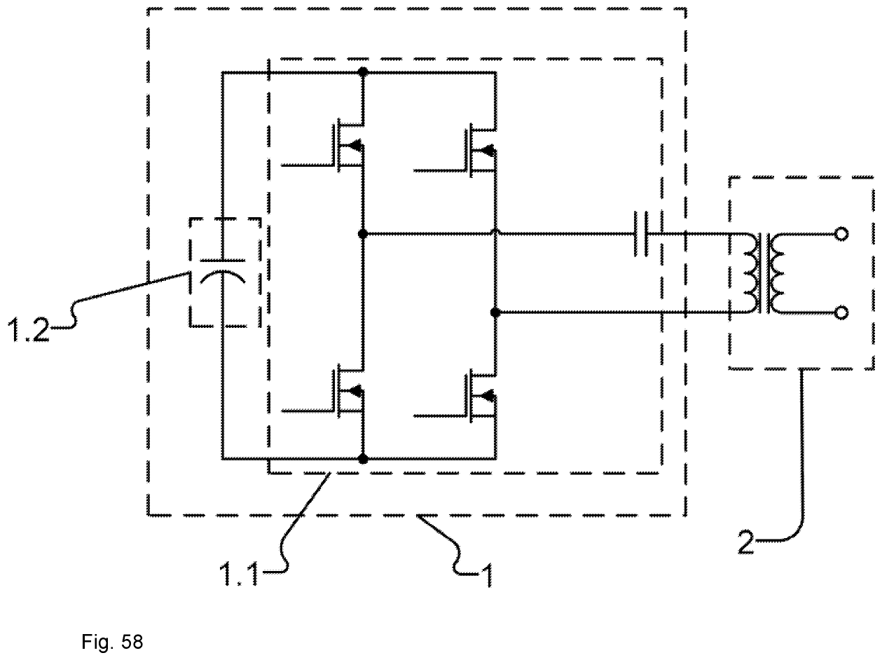

In FIG. 3b, the active injection of reactive power is produced in series to the secondary-side serial compensation capacitor C_{2S} as an embodiment example of the invention. The power electronics actuator in this example is made up of an H bridge with downstream serial capacitor C_{S} and an intermediate DC voltage store. The schematically shown embodiment example thus corresponds to a combination of FIG. 39 and FIG. 58. The compensation of the inductive transmission system can be detuned by the active generation and injection of a reactive power by the demonstrated adjustment principle, whereby the electrical output values of the system can be regulated.

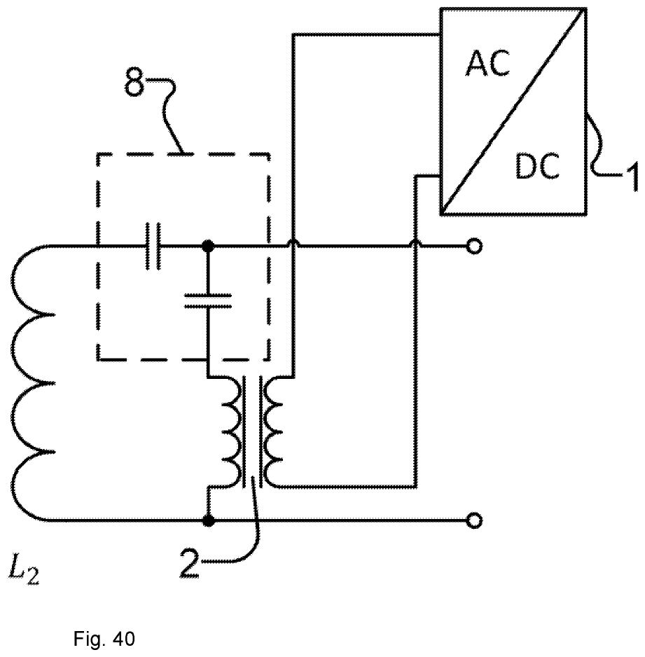

Another example according to the invention is shown schematically in FIG. 3c. In this embodiment example, the active injection of reactive power is produced in series to the secondary-side parallel compensation capacitor. As in FIG. 3b, the power electronics actuator is composed of an H bridge with downstream serial capacitor and an intermediate DC voltage store. The schematically shown embodiment example thus corresponds to a combination of FIG. 40 and FIG. 58. The compensation of the inductive transmission system can be detuned by active generation and injection of a reactive power by the demonstrated adjustment principle, whereby the electrical output values of the system can be regulated.

Simulation results are shown in FIGS. 4a-4f. These results can be summarized and evaluated as follows:
The output values of an inductive transmission system can be adjusted by means of the active injection of reactive power by targeted detuning in a secondary-side regulation according to the adjusting principle shown in FIGS. 3b and 3c.
The efficiency over the entire load region according to FIG. 4a is better than with the usual method according to the prior art, i.e., a short circuit control according to FIG. 3a.
A reduction in losses is possible both on the secondary side (rectifier according to FIG. 4e and secondary coil according to FIG. 4c) and on the primary side (inverter according to FIG. 4d), as well as in the actuator according to FIG. 4f.
The feedback of the reactive power injection on the primary side, measured at the phase angle of the inverter output values, can be influenced by the dimensioning of the serial capacitor (C_{S}) in the simulated exemplary embodiments. Therefore, a possible optimizing approach might be to design the C_{S} so that the feedback is minimal. As can be seen in FIG. 4b, in the case of reactive power injection in series to C_{2P}, the phase angle is approximately constant from full load to about ⅓ full load.
In systems of higher power, the actuator losses are still clearly smaller in the case of active injection of reactive power than in short circuit control, since the full load current flows through the short circuit switches (S₁ and S₂ in FIG. 3a), whereas a clearly smaller current is sufficient for the generation of reactive power. In addition, in the case of reactive power injection, switching losses are predominant: In embodiments with new power semiconductor technologies, e.g., based on gallium nitride (GaN), switching losses should clearly decrease. In contrast, in short circuit switches, state losses dominate, which still clearly increase in systems of higher power and further increase also with the use of GaN, since the MOSFETs employed have a clearly smaller state resistance than available GaN eHEMTs.
The realization of the active injection of reactive power still has much potential for optimization: In addition to an optimal design of the power electronics actuator, for example, the injection of reactive power could also be produced in parallel to a compensation capacitor. A combination could also offer advantages.
Thus, in systems with higher power and with optimal realization of reactive power injection, still higher efficiencies in the partial load region should be anticipated.
In addition, a large part of the charging process takes place in the partial load region. In charging systems of higher power, the fraction of the partial load region in the charging process increases further, for which reason, the increase in efficiency over the entire charging process is considered remarkable.

The following values are presented as simulation results:
efficiency;
phase angle at the feeding inverter between inverter output voltage and inverter output current;
ohmic power loss in the secondary winding;
power loss of the feeding inverter;
power loss of the rectifier;
power loss of the actuator.

All values here are plotted vs. the output power or the charging power.

FIG. 5 shows the influence of a variation in the secondary-side serial compensation capacitor (C_{2S}) by −10% on the transmissible effective power and—as an example of a robust operation—the equilibration of this variation by a dynamic tracking of the balance during operation by means of active injection of reactive power in series to the secondary-side serial compensation capacitor according to FIG. 3b. It can be seen that a drop of 10% in the capacity of the secondary-side serial capacitor leads to the circumstance that only about ⅓^{rd} of the effective power can still be transmitted. At time point t=0.01 s, by means of active injection of reactive power, capacitive reactive power is actively generated and is injected into the compensated coil system. As can be seen in FIG. 5, the parameter variation during operation can be equilibrated therewith. With this adjusting principle, the ideal balance can be tracked during operation, so that the full effective power can be transmitted despite parameter variation.

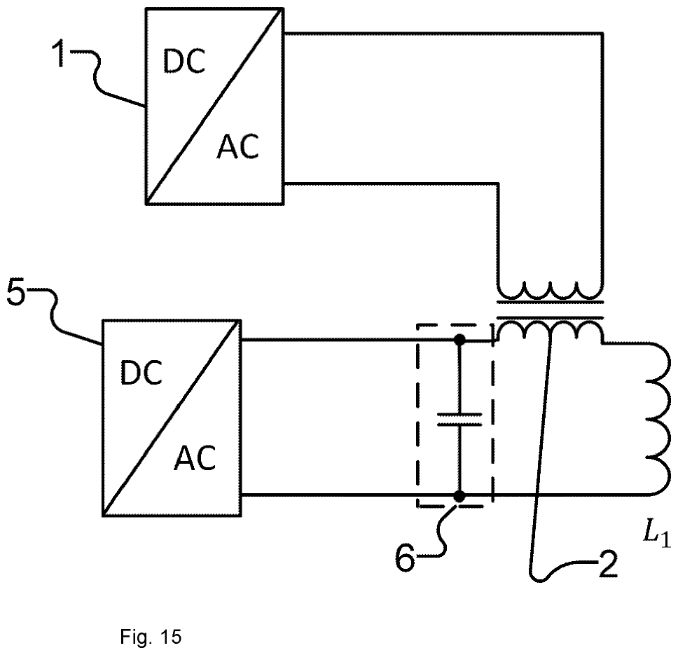

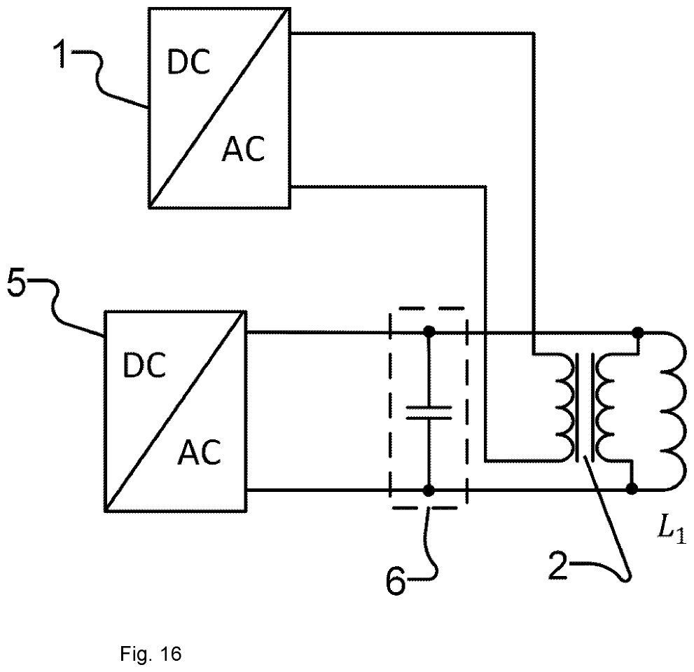

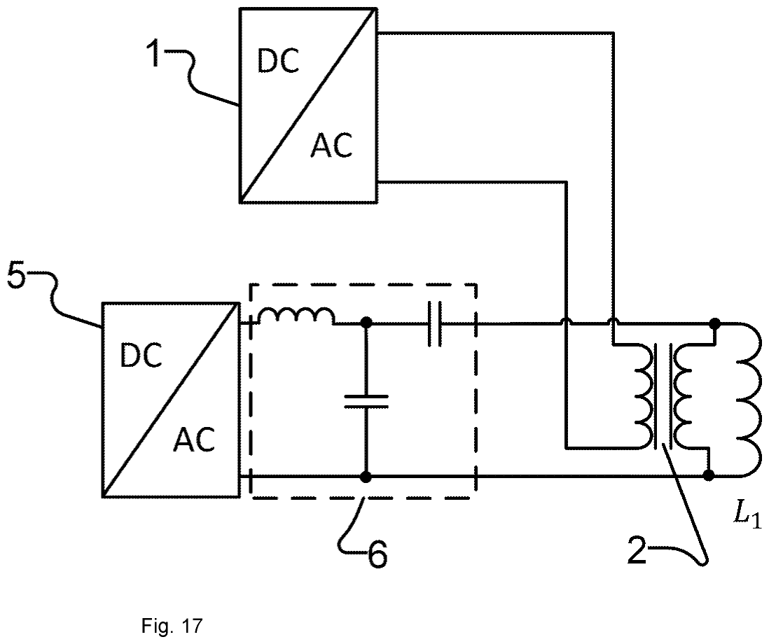

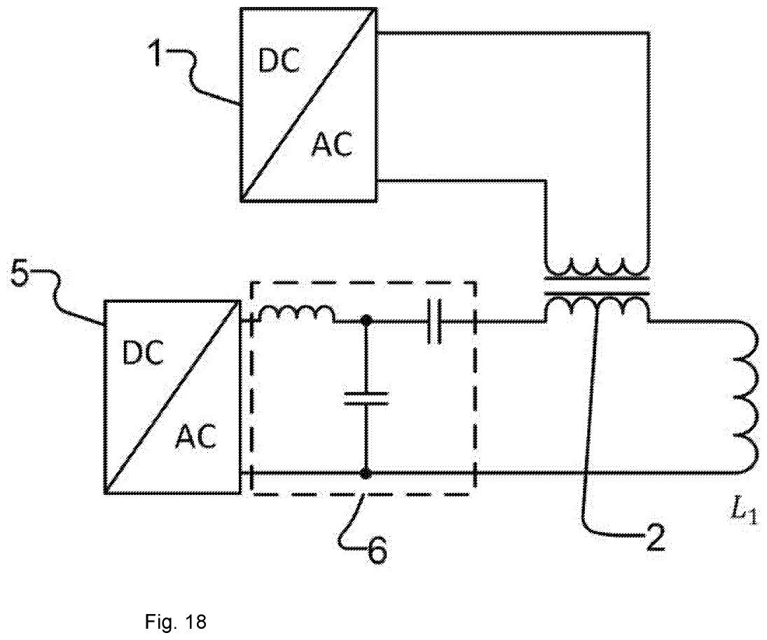

In FIG. 6 to FIG. 25, schematically different arrangements are shown for a primary-side active injection of reactive power. In FIG. 26 to FIG. 56, schematically different arrangements are shown for a secondary-side active injection of reactive power. These are combinable with one another. Thus, for example, for the simulated inductive transmission system according to FIGS. 3a to 3c, a combination of FIG. 18, FIG. 39, and FIG. 40 might be meaningful, since they could react selectively to parameter variations of the individual compensation capacitors.

In this case, a balance must be struck between the expense of additional components and the gain of degrees of freedom. A particular feature of the simulated resonance topology is the primary-side current injection. Here, the phase angle between the output values of the feeding inverter can be adjusted selectively by way of the primary-side compensation capacitor. This is an important parameter for losses on the primary side.

Thus, for example, with an embodiment of the active compensation of reactive power according to FIG. 18, this parameter could be regulated to an optimal value or could be kept in a permissible range during operation. Since the phase angle between the inverter output values is a primary-side value, such a regulation could also be combined with a secondary-side regulation without an additional communications channel. This effect also occurs in the schematically shown topologies according to FIGS. 19 to 21 and FIG. 24.

In FIGS. 57 to 64, embodiment examples of the device for the active generation of reactive power are shown schematically. These represent only a small fraction of the possible embodiments. In particular, the reproduction of a sinusoidal voltage by means of multipoint converters represents a very promising embodiment possibility for the active generation of reactive power.

The embodiment of the power electronics circuit for the generation of reactive power with an H bridge and a downstream analogous filter step, as shown in FIGS. 58 to 64 by way of example, connects the advantages of a small number of components and the possibility of also actively generating both capacitive as well as inductive reactive power with another degree of freedom in the design, since the dimensioning of the filter has an influence on the feedback of the active injection of reactive power in a secondary-side regulation on the primary side.

### LIST OF REFERENCE CHARACTERS

(1) Device for the active generation of reactive power
(1.1) Power electronics circuit
(1.2) Intermediate energy store
(2) Device for coupling in reactive power
(3) Apparatus for the active generation and injection of a reactive power into an inductive transmission system (12)
(4) Compensated coil system
(5) Feeding inverter
(6) Device for the primary-side compensation
(7) Coil system
(8) Device for the secondary-side compensation
(9) Rectifier
(10) Output filter
(11) Load/consumer
(12) Inductive transmission system
(L₁) Primary coil
(L₂) Secondary coil
(P) Primary side
(S) Secondary side
(C_{S}) Serial capacitor of the active generation of reactive power
(C_{2P}) Secondary-side parallel compensation capacitor
(C_{2S}) Secondary-side serial compensation capacitor

1. An apparatus (3) for the active generation and injection of a reactive power into an inductive transmission system (12), this apparatus comprising at least:
a device (1) for the active generation of a reactive power, wherein the reactive power can be actively generated by means of a power electronics actuator, this device comprising at least a power electronics circuit (1.1) and an intermediate electric energy store (1.2);
a device (2) for coupling in reactive power, wherein the reactive power generated by the device (1) can be coupled by way of a transformer into the inductive transmission system (12).

2. The apparatus (3) according to claim 1, further characterized in that the feeding of the device (1) for the active generation of reactive power is produced
from the inductive transmission system (12) or
from an additional energy source.

3. The apparatus (3) according to claim 1, wherein capacitive and/or inductive reactive power can be generated by means of the device (1).

4. The apparatus (3) according to claim 1, further characterized in that the reactive power coupling-in (2) is produced in series and/or parallel to one or more compensation capacitors.

5. The apparatus (3) according to claim 1, further characterized in that the reactive power coupling-in (2) is produced in series and/or parallel to a coil system (7).

6. The apparatus (3) according to claim 1, further characterized in that the reactive power coupling-in (2) is produced in series and/or parallel to a compensated coil system (4).

7. The apparatus (3) according to claim 1, further characterized in that the reactive power coupling-in (2) is produced on the primary side (P) and/or the secondary side (S) of the inductive transmission system (12).

8. The apparatus (3) according to claim 1, further characterized in that at least one reactive power coupling-in (2) is produced.

9. A method for operating the apparatus (3) according to claim 1 is hereby characterized in that the compensation of the inductive transmission system (12) is varied by the active generation and injection of reactive power into the compensated coil system (4).

10. The method according to claim 9, further characterized in that the compensation is continuously varied or continuously tracked during operation of the inductive transmission system (12).

11. The method according to claim 9, further characterized in that the compensation is detuned during operation by injection of a reactive power into the compensated coil system (4) in order to regulate at least one electrical value of the inductive transmission system (12), wherein, preferably, the flooding of the primary coil (L₁) and/or the voltage at the primary or secondary coil (L₂) is regulated.

12. The method according to claim 9, further characterized in that the compensation is detuned during operation in order to regulate at least one electrical output value of the inductive transmission system.

13. The method for operating the apparatus (3) according to claim 9, further characterized in that the ratio between two electrical values of the inductive transmission system is varied, preferably continuously varied during operation, by the active generation and injection of reactive power.

14. The method for operating the apparatus (3) according to claim 1, further characterized in that the phase angle between the output voltage and the output current of the feeding inverter is varied and/or limited, preferably continuously varied and/or limited during operation, by the active generation and injection of reactive power.
